(19) United States
(12) Patent Application Publication
(10) Pub. No.: US 2024/0202542 A1
(43) Pub. Date: Jun. 20, 2024

(54) METHODS FOR TRANSFER LEARNING IN CSI-COMPRESSION

(71) Applicant: Telefonaktiebolaget LM Ericsson (publ), Stockholm (SE)

(72) Inventors: Lars LINDBOM, Karlstad (SE); Rakesh RANJAN, Järfälla (SE)

(21) Appl. No.: 18/554,517

(22) PCT Filed: Mar. 30, 2022
(86) PCT No.: PCT/SE2022/050316

§ 371 Date: Oct. 9, 2023

Related U.S. Application Data
(60) Provisional application No. 63/201,123, filed on Apr. 14, 2021.

(51) Int. Cl. G06N 3/096; G06N 3/0455

(52) U.S. Cl. CPC G06N 3/096; G06N 3/0455

(57) ABSTRACT

According to an aspect, there is provided a method of training an autoencoder in a target domain. The autoencoder includes a first neural network encoder for use in a wireless device and a first neural network decoder for use in a base station. The method includes: obtaining a first set of weights; training a second neural network encoder in a source domain using a first data set to determine a first set of weights, wherein the second neural network encoder has the same structure as the first neural network encoder; setting weights of the first neural network encoder to the first set of weights; and training the first neural network decoder using a second data set, during which the weights of the first neural network encoder are fixed.

### TECHNICAL FIELD

This disclosure relates to the training of an autoencoder in a target domain, and to providing compressed Channel State Information (CSI) to a base station.

### BACKGROUND

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

The 5^{th} generation mobile wireless communication system (also known as New Radio (NR)) uses Orthogonal Frequency Division Multiplexing (OFDM) with configurable bandwidths and subcarrier spacing to efficiently support a diverse set of use cases and deployment scenarios. With respect to Long Term Evolution (LTE), NR provides improvements in deployment flexibility, user throughputs, latency and reliability. With NR also comes enhanced support for spatial multiplexing in which time-frequency resources are spatially shared across users, commonly referred to as Multi-User Multiple-Input Multiple-Output (MIMO) (MU-MIMO).

MU-MIMO operations are illustrated in FIG. 1 where a multi-antenna base station with N_{TX} antenna ports is spatially transmitting information to several user equipments (UEs), in which sequence S⁽¹⁾ is aimed for UE(1), S⁽²⁾ is aimed for UE(2), etc. Before modulation and transmission, precoding W_{V}^{(j)} is applied to each sequence to spatially separate the transmissions, i.e. to mitigate multiplexing interference.

At the receiver sides, each UE demodulates its received signal and combines receiver antenna signals in order to obtain an estimate Ŝ⁽ⁱ⁾ of transmitted sequence. This estimate Ŝ⁽ⁱ⁾ can be expressed as

$${\hat{S}}^{( i )} = {\underbrace{{W}_{U}^{( i )} {H}^{( i )} {W}_{V}^{( i )}}}_{\approx I} {S}^{( i )} + {W}_{U}^{( i )} {H}^{( i )} {\sum }_{j , j \neq i} {W}_{V}^{( j )} {S}^{( j )} ,$$

where the second term represents the spatial multiplexing interference seen by UE(i) and W_{U} is the weight matrix per UE in the Combiner that the UE uses to multiply the received channels from different antennas. The goal for the base station is to construct the set of precoders {W_{V}^{(j)}} such that the norm ∥H⁽ⁱ⁾W_{V}⁽ⁱ⁾∥ is large whereas the norm ∥H⁽ⁱ⁾W_{V}⁽ⁱ⁾∥, j≠i is small. In other words, the precoder W_{V}⁽ⁱ⁾ shall correlate well with the channel H⁽ⁱ⁾ observed by UE(i) whereas it shall correlate poorly with the channels observed by other UEs.

To construct precoders for efficient MU-MIMO transmissions, the base station needs to acquire detailed knowledge of the channels H(i). In deployments where channel reciprocity holds, channel knowledge can be acquired from sounding reference signals (SRS) that are transmitted periodically, or on demand, by active UEs. Based on these SRS, the base station estimates H⁽ⁱ⁾. However, when channel reciprocity does not hold, active UEs need to feedback channel details to the base station. In NR (as well as in LTE), this is done by having the base station to periodically transmit Channel State Information reference signals (CSI-RS) from which a UE can estimate its channel. The UE then reports CSI from which the base station can determine suitable precoders for MU-MIMO.

The CSI feedback mechanism targeting MU-MIMO operations in NR is referred to as CSI type II, in which a UE reports CSI feedback with high CSI resolution. It is based on specifying sets of Discrete Fourier Transform (DFT) base functions (grid of beams) from which the UE selects those that best match its channel conditions (like classical codebook Precoding Matrix Indicator (PMI)). In addition, the UE also reports how these beams should be combined in terms of relative amplitude scaling and co-phasing. The number of beams the UE reports is configurable, and may, for example, be 2 or 4. Reporting more beams increases the CSI resolution feedback, but at the cost of additional uplink transmissions overhead.

The CSI type II is illustrated in Figure Z from which it can be observed that the selection of DFT beam vectors bₙ, and their relative amplitudes aₙ, are determined from a wideband perspective whereas the co-phasing is per subband. Here, “wideband” means that the selected DFT beam vectors are the same for all subcarriers used in the OFDM transmission, whereas “subband” means that co-phasing parameters are determined over subsets of contiguous subcarriers. The co-phasing parameters are quantized such that e^{jθ}^{ₙ} is taken from either a Quadrature Phase Shift Keying (QPSK) or 8 Phase Shift Keying (8PSK) signal constellation.

With k denoting a sub-band index, the precoder reported by the UE can be expressed as

$${W}_{V} [ k ] = {\sum }_{n} {b}_{n} {a}_{n} {e}^{j {θ}_{n} [ k ]} .$$

When the base station (BS) schedules multiple UEs spatially, it may select UEs that have reported different set of beams or beams that have weak correlations. The CSI type II thus represents a MIMO channel feedback mechanism where a UE reports a precoder hypothesis that trades CSI resolution towards uplink transmission overhead.

CSI type II is a suboptimal precoding approach for MU-MIMO with respect to knowing the UE estimated MIMO channels at the base station, but explicit signalling of the full MIMO channel is not realistic given the resulting uplink capacity demands. However, signalling of a highly compressed MIMO channel is feasible and recently neural network based autoencoders have shown promising results in terms of providing good compression-decompression performance with realistic overhead.

An autoencoder (AE) is a type of artificial neural network (NN) that can be used for compression of features in an unsupervised manner, which here means that the AE works with only input data and no output labels are needed. These networks aim to reconstruct the input data at the output layer.

FIG. 3 illustrates an AE based on fully connected layers (a.k.a. Dense), where the neural network is divided into an encoder part and a decoder part. The output of the encoder, sometimes referred to as the bottleneck layer, represents the code values that are to be signalled. The AE is trained for a given input size, and code size, to provide small reconstructions errors. The optimization could e.g. refer to minimization of the mean-squared error (MSE) of the reconstruction error, X−\hat{X}.

The size of the code (shown as Y in FIG. 3) of the autoencoders is typically significantly smaller than the size of the input data (X). The encoder part of an AE reduces the spatial dimensionality of the input features with increasing depth of the neural network. The decoder basically does the inverse i.e. it gradually turns the compressed code to the original feature size and in the output layer. In other words, the decoder reconstructs the original input data with some loss (\hat{X}).

FIG. 4 illustrates how the AE can be applied to MIMO channels where the input to the encoder represents the MIMO channel estimated over several subcarriers (sc). For CSI compression used in the context of CSI feedback over the air interface, the encoder is implemented in the UE, whereas the decoder is here assumed to be implemented in the BS but could also be implemented in other locations associated with the cellular network. In principle, the encoder and decoder may be implemented in any suitable nodes in which exchange of CSI, or estimated/predicted MIMO channels, is of interest. One such example could be when base stations provide a centralized scheduling entity/node with CSI information over backhaul, where in this case the encoder is implemented in a BS and the decoder is implemented in a centralized scheduling entity/node.

Transfer learning is the learning enhancement in a new task through the transfer of knowledge from another related task that a machine learning model has already learnt. This may be particularly beneficial when the size of training data for an original task A is large and a model needs to be made for a related task B where there is not as much training data available to train the model convergingly.

With the technique of transfer learning the machine learning algorithms harness past training(s) and exploit them for new tasks. Without transfer learning, the machine learning algorithms are created for a given task and the dataset. This limits the ability of the machine learning algorithm as it cannot apply any previously obtained knowledge to new problems. In transfer learning, first a source model is trained on a dataset. Then the trained model or the weights of the neurons in different and desired layers may be saved and used for later instantiations of a model.

### SUMMARY

There currently exist certain challenge(s).

In existing solutions, the encoder and decoder of an autoencoder are jointly trained on a specific set of data. The problem with the existing solutions is that its difficult to find an autoencoder that generalizes to diverse channel distributions, in other words one may need to retrain the autoencoder to specific deployment scenarios. This leads to the need to reconfigure the UE with a scenario specific encoder, i.e. the encoder part of the autoencoder needs to be UE configurable. This implies signalling effort to convey a lot of encoder weight parameters.

Certain aspects of the present disclosure and their embodiments may provide solutions to these or other challenges.

Methods and apparatuses described herein utilize transfer learning to facilitate CSI-compression without retraining an encoder in an autoencoder structure. The encoder is pre-trained together with a decoder on some channel data that could e.g. refer to synthetic model based generated channels. The weights of the pre-trained encoder are frozen (made untrainable) whereas the decoder of the AE can be retrained on real measured channel data to adapt to channel conditions related to a real network deployment.

Embodiments described herein apply transfer learning in CSI compression to the encoder part of an autoencoder. A method may comprise:
training a source autoencoder on a first set of channel data to obtain a source encoder, for capturing the latent space of channel data features, and
training a target autoencoder on a second set of channel data with target encoder weights from the source encoder being untrainable.

The neural network architecture of the target encoder may be the same as the source encoder.

The neural network architecture of the target decoder can differ from the source decoder.

The first set of channel data may refer to synthetic generated channel data.

The second set of channel data may refer to real channel data.

One key feature of embodiments described herein is that the encoder and the decoder of an autoencoder is not necessarily jointly trained on the same set of channel data.

Another key feature of embodiments described herein is that an autoencoder can be trained for a specific deployment scenario without changing the encoder weights, and by then avoid the need to (re-)configure UEs with a scenario-specific encoder.

There are, proposed herein, various embodiments which address one or more of the issues disclosed herein.

According to a first aspect, there is provided a method of training an autoencoder in a target domain. The autoencoder comprises a first neural network encoder for use in a wireless device and a first neural network decoder for use in a base station. The method comprises obtaining a first set of weights; training a second neural network encoder in a source domain using a first data set to determine a first set of weights, wherein the second neural network encoder has the same structure as the first neural network encoder; setting weights of the first neural network encoder to the first set of weights; and training the first neural network decoder using a second data set, during which the weights of the first neural network encoder are fixed.

According to a second aspect, there is provided a method performed by a wireless device for providing a compressed Channel State Information (CSI) to a base station. The wireless device comprising a neural network encoder configured to determine the compressed Channel State Information (CSI), wherein the neural network encoder is configured with a first set of weights. The method comprises signalling an indication of a type of the neural network encoder to the base station.

According to a third aspect, there is provided a method performed by a base station for determining Channel State Information (CSI). The base station comprises a neural network decoder configured to decompress compressed CSI received from a wireless device, wherein a neural network encoder in the wireless device is configured with a first set of weights. The method comprises receiving an indication of a type of neural network encoder used by a wireless device.

According to a fourth aspect, there is provided a computer program product comprising a computer readable medium having computer readable code embodied therein, the computer readable code being configured such that, on execution by a suitable computer or processor, the computer or processor is caused to perform the method according to the first aspect, the second aspect, the third aspect, or any embodiment thereof.

According to a fifth aspect, there is provided a network node for training an autoencoder. The autoencoder comprises a first neural network encoder for use in a wireless device and a first neural network decoder for use in a base station. The network node comprises processing circuitry configured to: receive obtain a first set of weights; set the weights of a first neural network encoder to the first set of weights; and train the first neural network decoder using a second data set, during which the weights of the first neural network encoder are fixed.

According to a sixth aspect, there is provided a wireless device configured to provide a compressed Channel State Information, CSI, to a base station. The wireless device comprises a neural network encoder configured to determine the compressed CSI, wherein the neural network encoder is configured with a first set of weights. The wireless device is configured to: signal an indication of a type of the neural network encoder to the base station.

According to a seventh aspect, there is provided a base station configured to determine Channel State Information, CSI. The base station comprises a neural network decoder configured to decompress compressed CSI received from a wireless device, wherein a neural network encoder in the wireless device is configured with a first set of weights. The base station is configured to receive an indication of a type of neural network encoder used by a wireless device.

According to an eighth aspect, there is provided a network node for training an autoencoder. The autoencoder comprises a first neural network encoder for use in a wireless device and a first neural network decoder for use in a base station. The network node comprises a processor and a memory, said memory containing instructions executable by said processor whereby said network node is operative to: obtain a first set of weights; set the weights of a first neural network encoder to the first set of weights; and train the first neural network decoder using a second data set, during which the weights of the first neural network encoder are fixed.

According to a ninth aspect, there is provided a wireless device configured to provide a compressed Channel State Information, CSI, to a base station. The wireless device comprises a neural network encoder configured to determine the compressed CSI, wherein the neural network encoder is configured with a first set of weights. The wireless device comprises a processor and a memory, said memory containing instructions executable by said processor whereby said wireless device is operative to signal an indication of a type of the neural network encoder to the base station.

According to a tenth aspect, there is provided a base station configured to determine Channel State Information, CSI. The base station comprises a neural network decoder configured to decompress compressed CSI received from a wireless device, wherein a neural network encoder in the wireless device is configured with a first set of weights. The base station comprises a processor and a memory, said memory containing instructions executable by said processor whereby said base station is operative to receive an indication of a type of neural network encoder used by a wireless device.

Certain embodiments may provide one or more of the following technical advantage(s).

With embodiments described herein there is no need for retraining and explicit signalling of new encoder weights (parameters) to refine the autoencoder to a specific deployment scenario.

Another major advantage is that the encoder part of the autoencoder may be standardized using only synthetic channel data. As the autoencoder is trained on synthetic data, there is no need for real data from alive network during model development, presuming that the synthetic channel data models the real channels to an acceptable level.

### BRIEF DESCRIPTION OF THE DRAWINGS

Some of the embodiments contemplated herein will now be described more fully with reference to the accompanying drawings, in which:

FIG. 1 illustrates MU-MIMO operations;

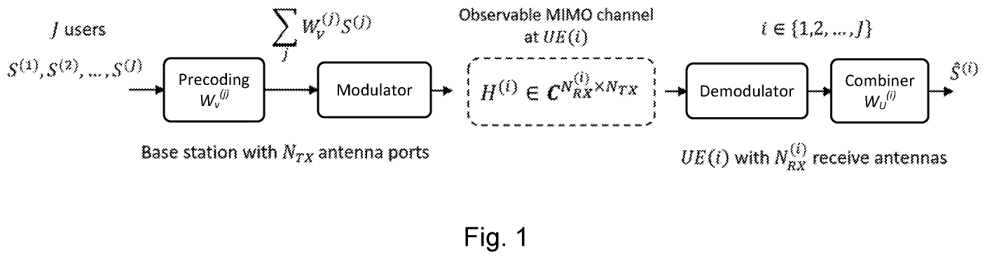

FIG. 2 illustrates CSI type II feedback;

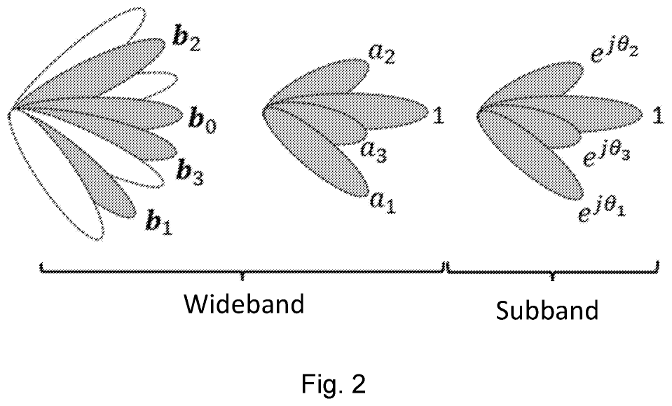

FIG. 3 is an illustration of a fully connected autoencoder;

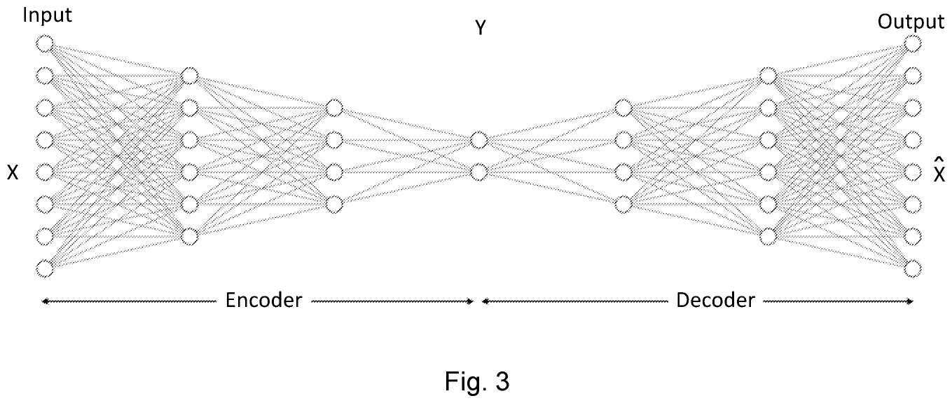

FIG. 4 illustrates the use of an autoencoder for CSI compression;

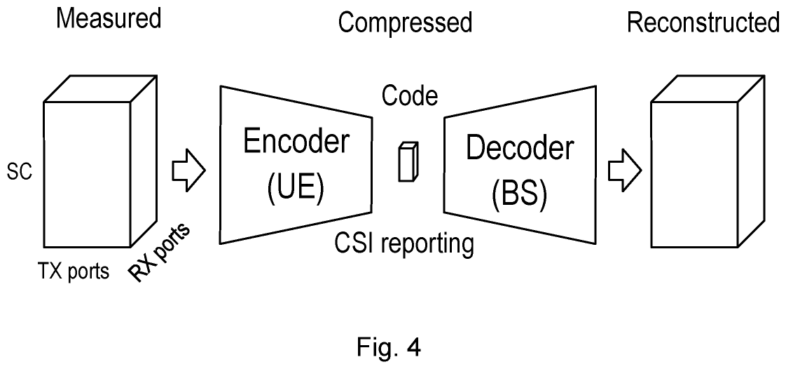

FIG. 5 is an illustration of transfer learning in CSI compression using autoencoders;

FIG. 6 illustrates a method of training an autoencoder in a target domain;

FIG. 7 illustrates a flow of transfer leaning for optimal CSI compression;

FIG. 8 illustrates a method performed by a wireless device for providing a compressed CSI to a base station;

FIG. 9 illustrates a method performed by a base station for determining CSI;

FIG. 10 is a graph illustrating power density distributions of CIR;

FIG. 11 is a graph showing a comparison with/without transfer learning when the autoencoder is trained on UMa channel data;

FIG. 12 is a graph showing a comparison with/without transfer learning when the autoencoder is trained on UMi channel data;

FIG. 13 shows an example of a wireless network in accordance with some embodiments;

FIG. 14 shows a UE in accordance with some embodiments;

FIG. 15 is a block diagram illustrating a virtualization environment in which functions implemented by some embodiments may be virtualized;

FIG. 16 shows a telecommunication network connected via an intermediate network to a host computer in accordance with some embodiments;

FIG. 17 shows a host computer communicating via a base station with a user equipment over a partially wireless connection in accordance with some embodiments;

FIGS. 18-21 show methods implemented in a communication system including a host computer, a base station and a user equipment in accordance with some embodiments;

FIG. 22 shows virtualization apparatus in accordance with some embodiments;

FIG. 23 shows another virtualization apparatus in accordance with some embodiments; and

FIG. 24 shows another virtualization apparatus in accordance with some embodiments.

### DETAILED DESCRIPTION

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

### Transfer Learning for CSI Compression

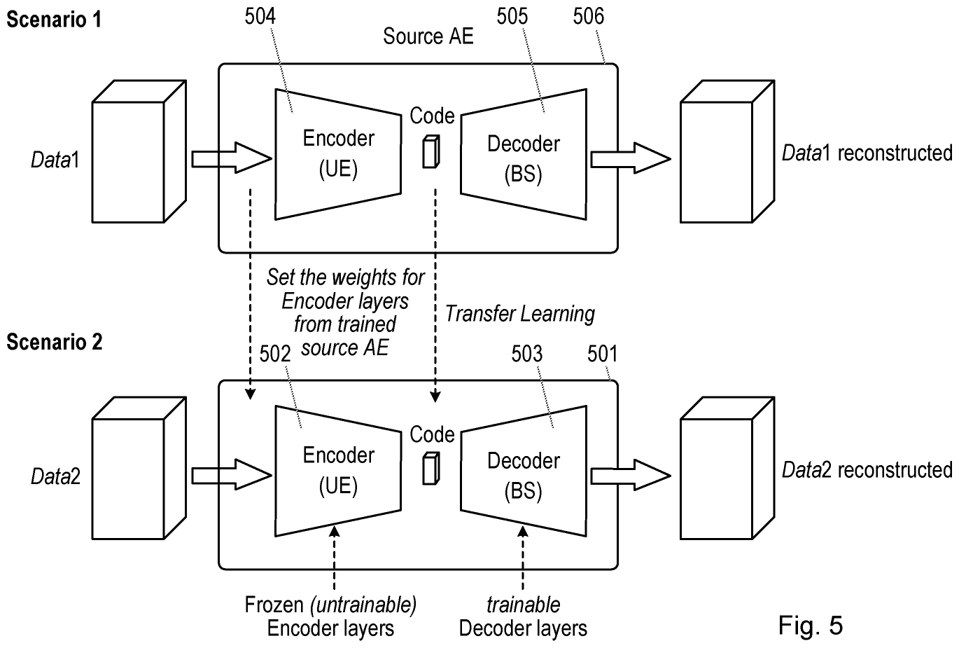

The transfer learning concept described above can be applied for CSI compression as illustrated in FIG. 5. The aim is to produce the first autoencoder 501. The first autoencoder 501 comprises an encoder 502 and a decoder 503.

In the upper part of the figure (e.g. in scenario 1), a second autoencoder 506 comprising a second encoder 504 and second decoder 505 is trained on channel data from the data set “Data1” to e.g. minimize the MSE of the reconstruction error. The encoder weights resulting from the training of the second autoencoder performed using “Data1” are transferred into the first encoder 502 where they are made untrainable. In Scenario 2, the first autoencoder 501 is trained on channel data from the data set “Data2” where only the weights of the first decoder 503 can be changed during this training phase (including backpropagation).

Scenario 1 may in this description be referred to as the “source domain” in which the main objective is to train an AE-encoder using source domain datasets. The AE-encoder is trained together with an AE-decoder for a given loss function, or cost function.

Scenario 2 may in this description be referred to as the “target domain” in which the main objective is to train an AE-decoder using target domain datasets. The AE-decoder is trained together with the AE-encoder obtained from the source domain training, but the AE-encoder is not changed during the training of the AE-decoder, i.e., parameters or weights defining the AE-encoder are frozen and thus not trainable. The architecture of the AE-decoder and the loss function may differ from what were used in the source domain training.

Source domain datasets are data that may refer to synthetic data or any data that are representative for the use case of the autoencoder. The source domain datasets may, as an example, refer to data that has been collected from a large number of deployment scenarios, whereas target domain datasets may refer to data that is representative of a specific deployment scenario. It is not precluded that target domain datasets are the same as, or a subset of, the data used in the source domain training, and potentially with the architecture of the AE-decoder and/or the loss function being the difference from the source domain training.

The AE-encoder associated with the source domain training may be the outcome of standardization work done in Standards Development Organizations (SDOs) such as the 3^{rd} Generation Partnership Project (3GPP), or it may be provided by a Communications Service Provider (CSP) such as a mobile network operator, or it may be provided by a third party, or it may be provided by the network vendor implementing the target AE-decoder. The parameters or weights of one or more AE-encoders, as well as any meta-data related to an AE-encoder, may be stored in a repository that can be accessed by a target domain.

The training of the AE-decoder in the target domain may occur in a development domain that typically is in the control of the vendor responsible for implementing or deploying the AE-decoder in a radio access network (RAN) node such as a base station. The development domain has an interface to the mobile network for the purpose of updating and maintaining RAN node functionality. The target domain AE-decoder may occasionally be re-trained on new or additional target domain datasets.

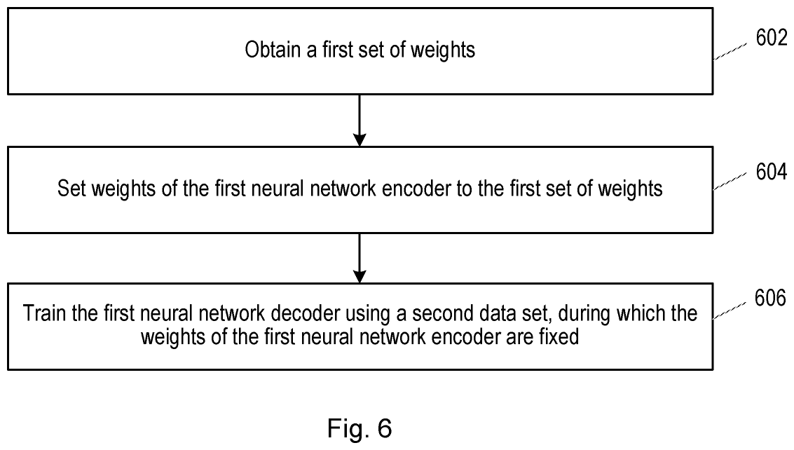

FIG. 6 illustrates a method of training an autoencoder in a target domain, wherein the autoencoder comprises a first neural network encoder for use in a wireless device and a first neural network decoder for use in a base station. It will be appreciated that the first neural network decoder may be used in other suitable network nodes, for example a network node with a real-time interface to a base station. The method in FIG. 6 can be performed by a network node such as a base station, or a centralized node or entity in a network.

The method begins at step 602 in which a first set of weights is obtained.

In some embodiments, step 602 comprises obtaining the first set of weights by training a second neural network encoder in a source domain using a first data set to determine the first set of weights, wherein the second neural network encoder has the same structure as the first neural network encoder. It will be appreciated that the second neural network encoder may be trained concurrently with a second neural network decoder (as illustrated in FIG. 6). Step 602 may be performed as part of the specification of the encoder, and may not therefore be performed within any network node.

In alternative embodiments, step 602 comprises receiving the first set of weights. The first set of weights can be received by downloading them from a database, memory or other storage that is accessible by the network (or RAN) node in which the target training is performed.

In step 604, the method comprises setting weights of the first neural network encoder to the first set of weights. In step 606, the method comprises training the first neural network decoder using a second data set, during which the weights of the first neural network encoder are fixed.

Step 606 may be performed within a centralized network node (server) that is connected/associated to self-organising network (SON) optimization management.

All training may be performed offline within the cellular network, where the source data is used to define/specify encoders, and the target (real) data is used to adapt/design/train the decoder to the actual radio channel conditions. In practice, the offline re-training of the decoder may need to be performed using on uplink measurements, as it may not be possible to have access to (uncompressed) UE channel measurements.

In some examples, the first data set comprises simulated channel data of a wireless channel. In some examples, the second data set comprises measurements, and in some other examples, the second data set comprises uplink measurements.

In some examples, the wireless device signals a type of the first neural network encoder to the base station.

The first neural network decoder may in some examples be of a different structure to a second neural network decoder in the source domain. For example, the structure of the first decoder 503 may be different from the structure of the second decoder 505. For example, the second decoder 505 may comprise a Convolutional 1-Dimensional (1D) layers whereas the first decoder 503 may comprise a Convolutional 2-Dimensional (2D) layers. The decoders in the different steps may also have a different number of layers. Therefore, there are no restrictions on the decoder architecture.

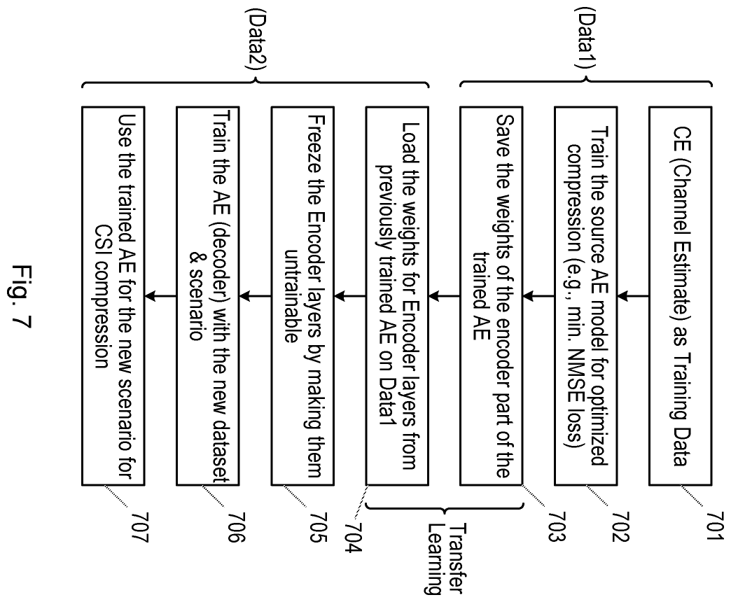

The transfer learning steps are further outlined in FIG. 7 where training data set “Data1” may refer to channel estimates collected from link simulators using e.g. 3GPP MIMO channel models (step 701). The second AE trained on Data1 represents the source AE (step 702), from which encoder weights are saved (step 703) and transferred to the first AE, e.g. the target AE. The target AE is constructed with the first encoder 503 (also called the target encoder) having same architecture as the second encoder 505 (also called the source encoder) in the source AE, while the second decoder (also called the source decoder) and first decoder (also called the target decoder) can have either the same or a different architecture. The weights for the encoder layers of the target AE are set using the encoder weights saved from the trained source AE (step 704). The encoder weights of the target AE are frozen by making them untrainable (step 705). The target AE is then trained on data set “Data2” that consists of channel data (e.g. channel estimates) collected from the scenario of interest and may refer to real channel measurements (step 706). The weights of the trainable target decoder may (pre-training phase) be either randomly initialized or initialized with the weights from the source decoder if they share the same architecture. The trained AE is used for a new scenario for CSI compression (step 707).

When using convolutional neural network (CNN) based autoencoders, it may be advantageous to use 1D layers in transfer learning encoders to avoid building in too strong correlations across antenna ports, as such correlations may differ for different antenna setups at base stations as well as at UEs.

In some examples, a plurality of target encoder structures may be defined wherein each target encoder structure is pre-trained (e.g. tailored) towards pre-specified antenna configurations at either a BS or a UE or both. One example is to account for UEs that have a different number of receive antenna ports, such that UEs with e.g. two and four receive antenna ports use different target encoders structures. In this example, the UE may indicate the target encoder structure that it is configured with, for example via (capability) signalling.

When training source encoders for transfer learning, regularization of the encoder layers may be considered for possibly better generalizing to other channel data than those used for encoder training.

In the example of FIG. 5, the target encoder compresses MIMO channels estimated by the UE from downlink reference signals. In a real network, it may not be possible to collect MIMO channel estimates from the UE for training and therefore transfer learning to refine the decoder of the autoencoder alongside an untrainable encoder may rely on uplink channel data (e.g. estimates).

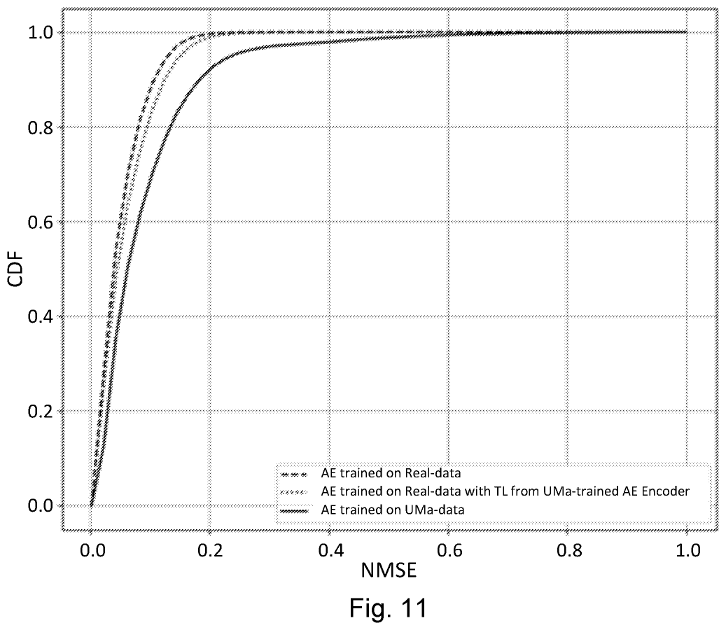

In Frequency Division Duplex (FDD) deployments where DL and UL signals are transmitted on different carrier frequencies, some difference in channel characteristics (such as power distributions of channel impulse responses) may occur due to non-reciprocity. However, this is likely a non-issue as UL-DL carrier frequencies are usually separated in terms of tens/hundreds of MHz rather than GHz. Furthermore, transfer learning in the context of CSI compression using autoencoders tends to be robust to variations in channel characteristics, as illustrated with reference to FIGS. 10 to 12 below.

According to some embodiments there is provided a network node for training an autoencoder. The network node may comprise a centralized network node (server) that is connected/associated to SON optimization management.

The autoencoder may comprise a first neural network encoder for use in a wireless device and a first neural network decoder for use in a base station (or any other suitable network node).

The network node obtains a first set of weights. In some embodiments, the first set of weights are received. In alternative embodiments, the first set of weights is obtained by training a second neural network encoder in a source domain using a first data set to determine the first set of weights. The second neural network encoder has the same structure as the first neural network encoder. It will be appreciated that the second neural network encoder may be trained concurrently with a second neural network decoder.

The network node sets the weights of a first neural network encoder to the first set of weights; and trains the first neural network decoder using a second data set, during which the weights of the first neural network encoder are fixed.

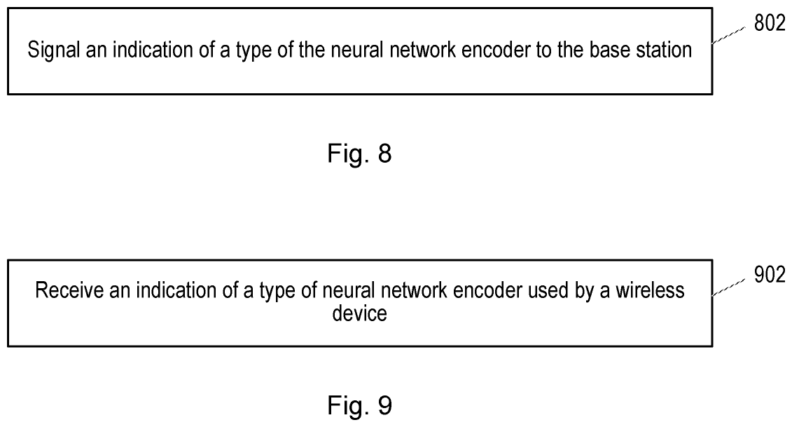

FIG. 8 illustrates a method performed by a wireless device for providing a compressed Channel State Information (CSI) to a base station, the wireless device comprising a neural network encoder configured to determine the compressed Channel State Information (CSI), wherein the neural network encoder is configured with a first set of weights. It will be appreciated that the neural network encoder may comprise a first (target) encoder, such as described with reference to FIGS. 5 to 7.

In step 802, the method comprises signalling an indication of a type of the neural network encoder to the base station. The network may then, based on the indication of the type of neural network encoder implemented by the wireless device, select a decoder that has been trained on target data under the assumption that the encoder is of the type used by the wireless device.

For example, the wireless device may receive an update to one or more of the first set of weights from the base station. The update may be received via Radio Resource Control signalling. In some examples, the wireless device may store the original first set of weights. In some embodiments, the method in the wireless device further comprises receiving a request from the base station to convert back to the first set of weights.

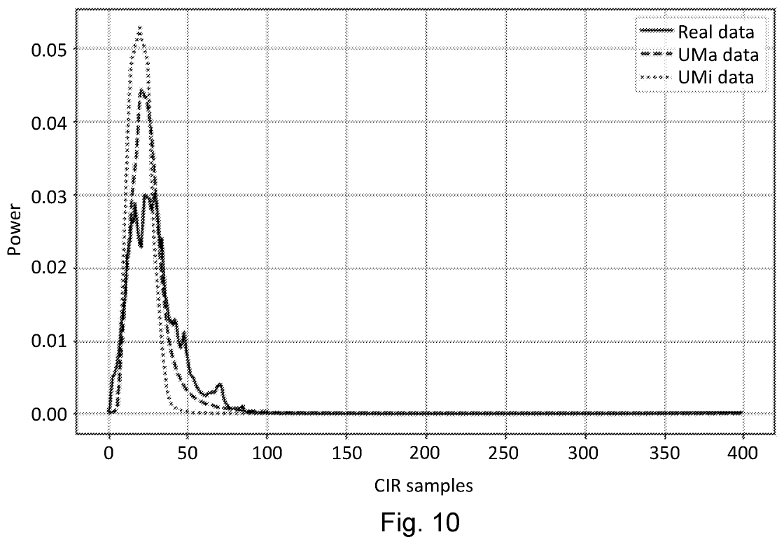

FIG. 9 illustrates a method performed by a base station for determining Channel State Information (CSI), the base station comprising a neural network decoder configured to decompress compressed CSI received from a wireless device, wherein a neural network encoder in the wireless device is configured with a first set of weights.

In step 902, the method comprises receiving an indication of a type of the neural network encoder used by a wireless device. The network may then, based on the indication of the type of neural network encoder implemented by the wireless device, select a decoder that has been trained on target data under the assumption that the encoder is of the type used by the wireless device.

The base station may then decode or decompress the compressed CSI using the selected decoder.

One of the advantages of utilising transfer learning, as described above, is to avoid configuring a wireless device with a new encoder, or with new encoder weights, as this would require signalling of a large amount of data. However, in some examples, the network may re-configure a subset of the first set of weights at the wireless device. In this way, an update to the neural network encoder requires much less signalling effort. One example is that the cellular network may re-configure the encoder weights of the last layer, i.e. the bottleneck layer of the autoencoder which has the smallest amount of weight parameters.

For example, the base station may send an update to one or more of the first set of weights to the wireless device. The update may be sent via Radio Resource Control signalling. In some examples, the wireless device may store the original first set of weights. In some examples, the cellular network (e.g. a BS) may have the possibility to re-configure some weights of a pre-specified encoder. This re-configuration could e.g. be done by RRC signalling.

In some examples, the base station may send a request to the wireless device to convert back to the first set of weights. For example, an additional signalling parameter may be introduced to inform a wireless device (that has been re-configured) to use the pre-specified weights, and by this avoid a further signalling of data to set the encoder weights back to the pre-specified first set of weights.

### Experimental Results

To validate the transfer learning concept, an AE was built with encoder and decoder corresponding to a 1D fully convolutional neural network (e.g. no dense layers are used). When applied to MIMO channels, the input to the AE is constructed by concatenating the MIMO channels into 1D arrays.

The deployment scenarios refer here to an OFDM based air interface operating at 2.6 GHZ, with 20 MHz system bandwidth and 45 kHz subcarrier spacing. For generating synthetic channel data, the 3GPP TR.38.901 propagation models for Urban Macro (UMa) and Urban Micro (UMi) are used, from which a source AE is trained on either UMa or UMi channel data. Here, the target AE has the same architecture as the source AE and is trained on channel estimates collected from real uplink measurements within a Macro network deployment.

The power density distributions of the channel impulse response (CIR) for the considered channels are depicted in FIG. 10, from which it can be observed that of the synthetic channel data the one related to the UMa (dashed) is closer to the CIR power distribution of the real channel data (solid). Hence, it may be expected that the source AE trained on UMa data will work better for transfer learning.

As a CSI compression performance metric, reconstruction errors may be calculated and the corresponding Cumulative Distribution Functions (CDFs) of the normalized MSE (NMSE) may be plotted. The performance comparisons are for:
1. AE trained on real training data and validated on real test data;
2. AE trained on synthetic training data and validated on real test data;
   a. Encoder part used in transfer learning (TL)
3. AE with TL frozen encoder trained on real training data and validated on real test data.

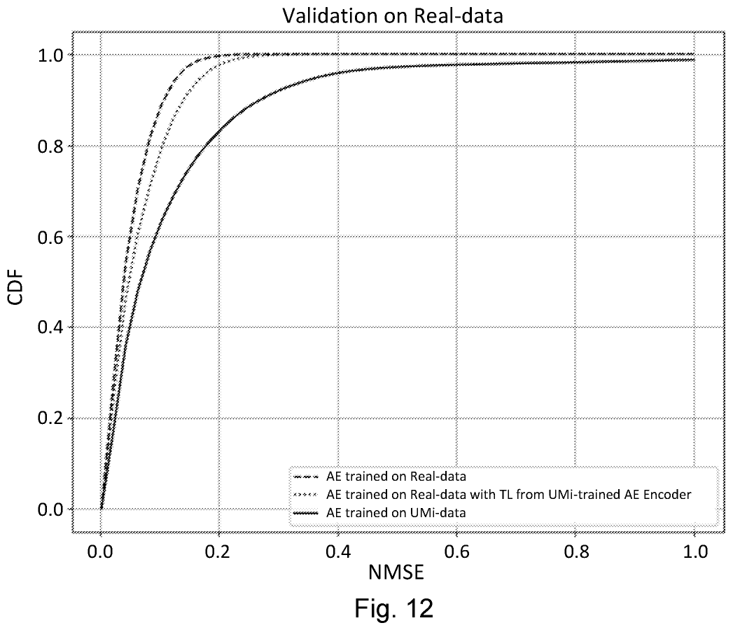

FIG. 11 shows the CDF plots of the NMSE for the three cases above when the source AE has been trained on UMa channel data. The following observations can be made:
The dashed plot is for the AE where both the encoder and the decoder are jointly trained on real data and thus represents the scenario where the AE can be optimized for a specific deployment. This case will provide the best performance but requires the encoder to be configurable at the UE.
The solid plot is for the AE where both the encoder and the decoder are jointly trained on the UMa channel data. Evidently, the AE trained on the synthetic data does not generalize very well to the real channel data.
The dotted plot is for the AE with transfer learning of the encoder from a source AE trained on UMa channel data, where the AE (untrainable encoder and trainable decoder) is trained on the real data channel data. Clearly, the transfer learning improves the performance significantly; almost on par with the scenario-specific trained AE.

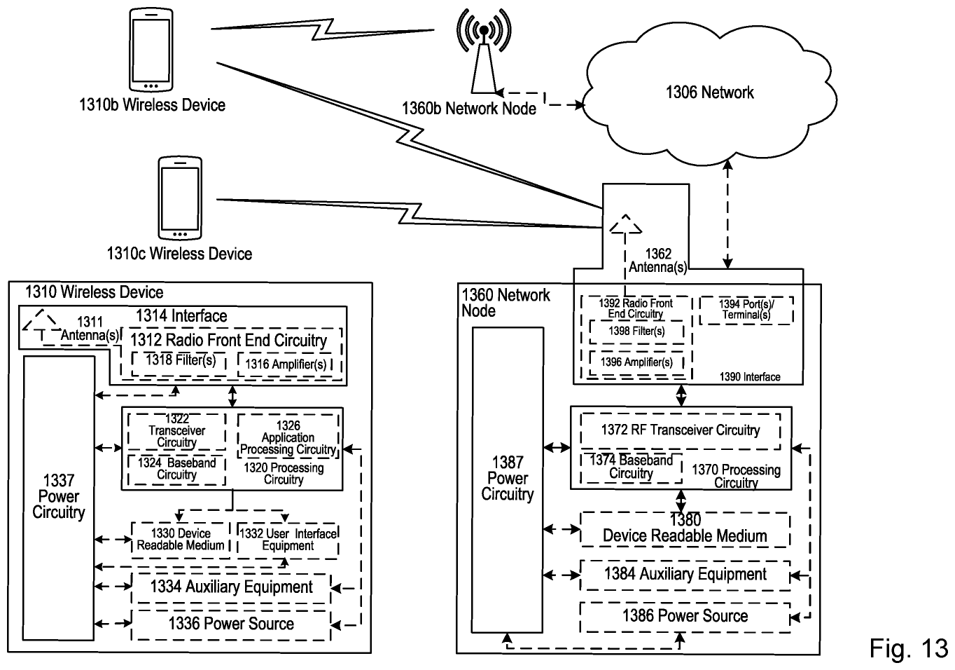

FIG. 12 shows the CDF plots of the NMSE for the three performance comparisons stated above when the source AE has been trained on UMi channel data. As in FIG. 11 it may be observed that transfer learning significantly improves the performance, even when CIR characteristics of the synthetic channel data largely differ from those of the real data. By comparing the dotted plots in FIG. 10 and FIG. 11, it may be observed that transfer learning improves when synthetic data characteristics are closer to the real data. This was expected, but the differences are not that large so it may be concluded that transfer learning is remarkably robust to source data characteristics.

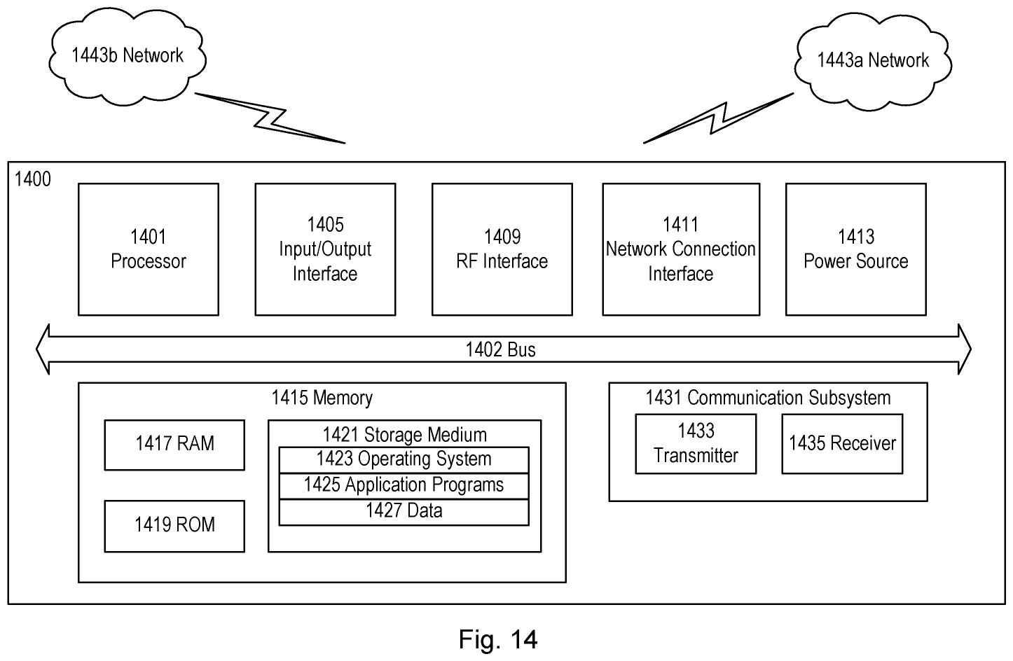

Although the subject matter described herein may be implemented in any appropriate type of system using any suitable components, the embodiments disclosed herein are described in relation to a wireless network, such as the example wireless network illustrated in FIG. 13. For simplicity, the wireless network of FIG. 13 only depicts network 1306, network nodes 1360 and 1360b, and WDs 1310, 1310b, and 1310c. In practice, a wireless network may further include any additional elements suitable to support communication between wireless devices or between a wireless device and another communication device, such as a landline telephone, a service provider, or any other network node or end device. Of the illustrated components, network node 1360 and wireless device (WD) 1310 are depicted with additional detail. The wireless network may provide communication and other types of services to one or more wireless devices to facilitate the wireless devices' access to and/or use of the services provided by, or via, the wireless network.

The wireless network may comprise and/or interface with any type of communication, telecommunication, data, cellular, and/or radio network or other similar type of system. In some embodiments, the wireless network may be configured to operate according to specific standards or other types of predefined rules or procedures. Thus, particular embodiments of the wireless network may implement communication standards, such as Global System for Mobile Communications (GSM), Universal Mobile Telecommunications System (UMTS), Long Term Evolution (LTE), and/or other suitable 2G, 3G, 4G, or 5G standards; wireless local area network (WLAN) standards, such as the IEEE 802.11 standards; and/or any other appropriate wireless communication standard, such as the Worldwide Interoperability for Microwave Access (WiMax), Bluetooth, Z-Wave and/or ZigBee standards.

Network 1306 may comprise one or more backhaul networks, core networks, IP networks, public switched telephone networks (PSTNs), packet data networks, optical networks, wide-area networks (WANs), local area networks (LANs), wireless local area networks (WLANs), wired networks, wireless networks, metropolitan area networks, and other networks to enable communication between devices.

Network node 1360 and WD 1310 comprise various components described in more detail below. These components work together in order to provide network node and/or wireless device functionality, such as providing wireless connections in a wireless network. In different embodiments, the wireless network may comprise any number of wired or wireless networks, network nodes, base stations, controllers, wireless devices, relay stations, and/or any other components or systems that may facilitate or participate in the communication of data and/or signals whether via wired or wireless connections.

As used herein, network node refers to equipment capable, configured, arranged and/or operable to communicate directly or indirectly with a wireless device and/or with other network nodes or equipment in the wireless network to enable and/or provide wireless access to the wireless device and/or to perform other functions (e.g., administration) in the wireless network. Examples of network nodes include, but are not limited to, access points (APs) (e.g., radio access points), base stations (BSs) (e.g., radio base stations, Node Bs, evolved Node Bs (eNBs) and NR NodeBs (gNBs)). Base stations may be categorized based on the amount of coverage they provide (or, stated differently, their transmit power level) and may then also be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS). Yet further examples of network nodes include multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), core network nodes (e.g., MSCs, MMEs), O&M nodes, OSS nodes, SON nodes, positioning nodes (e.g., E-SMLCs), and/or MDTs. As another example, a network node may be a virtual network node as described in more detail below. More generally, however, network nodes may represent any suitable device (or group of devices) capable, configured, arranged, and/or operable to enable and/or provide a wireless device with access to the wireless network or to provide some service to a wireless device that has accessed the wireless network.

In FIG. 13, network node 1360 includes processing circuitry 1370, device readable medium 1380, interface 1390, auxiliary equipment 1384, power source 1386, power circuitry 1387, and antenna 1362. Although network node 1360 illustrated in the example wireless network of FIG. 13 may represent a device that includes the illustrated combination of hardware components, other embodiments may comprise network nodes with different combinations of components. It is to be understood that a network node comprises any suitable combination of hardware and/or software needed to perform the tasks, features, functions and methods disclosed herein. Moreover, while the components of network node 1360 are depicted as single boxes located within a larger box, or nested within multiple boxes, in practice, a network node may comprise multiple different physical components that make up a single illustrated component (e.g., device readable medium 1380 may comprise multiple separate hard drives as well as multiple RAM modules).

Similarly, network node 1360 may be composed of multiple physically separate components (e.g., a NodeB component and a RNC component, or a BTS component and a BSC component, etc.), which may each have their own respective components. In certain scenarios in which network node 1360 comprises multiple separate components (e.g., BTS and BSC components), one or more of the separate components may be shared among several network nodes. For example, a single RNC may control multiple NodeB's. In such a scenario, each unique NodeB and RNC pair, may in some instances be considered a single separate network node. In some embodiments, network node 1360 may be configured to support multiple radio access technologies (RATs). In such embodiments, some components may be duplicated (e.g., separate device readable medium 1380 for the different RATs) and some components may be reused (e.g., the same antenna 1362 may be shared by the RATs). Network node 1360 may also include multiple sets of the various illustrated components for different wireless technologies integrated into network node 1360, such as, for example, GSM, WCDMA, LTE, NR, WiFi, or Bluetooth wireless technologies. These wireless technologies may be integrated into the same or different chip or set of chips and other components within network node 1360.

Processing circuitry 1370 is configured to perform any determining, calculating, or similar operations (e.g., certain obtaining operations) described herein as being provided by a network node. These operations performed by processing circuitry 1370 may include processing information obtained by processing circuitry 1370 by, for example, converting the obtained information into other information, comparing the obtained information or converted information to information stored in the network node, and/or performing one or more operations based on the obtained information or converted information, and as a result of said processing making a determination.

Processing circuitry 1370 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1360 components, such as device readable medium 1380, network node 1360 functionality. For example, processing circuitry 1370 may execute instructions stored in device readable medium 1380 or in memory within processing circuitry 1370. Such functionality may include providing any of the various wireless features, functions, or benefits discussed herein. In some embodiments, processing circuitry 1370 may include a system on a chip (SOC).

In some embodiments, processing circuitry 1370 may include one or more of radio frequency (RF) transceiver circuitry 1372 and baseband processing circuitry 1374. In some embodiments, radio frequency (RF) transceiver circuitry 1372 and baseband processing circuitry 1374 may be on separate chips (or sets of chips), boards, or units, such as radio units and digital units. In alternative embodiments, part or all of RF transceiver circuitry 1372 and baseband processing circuitry 1374 may be on the same chip or set of chips, boards, or units

In certain embodiments, some or all of the functionality described herein as being provided by a network node, base station, eNB or other such network device may be performed by processing circuitry 1370 executing instructions stored on device readable medium 1380 or memory within processing circuitry 1370. In alternative embodiments, some or all of the functionality may be provided by processing circuitry 1370 without executing instructions stored on a separate or discrete device readable medium, such as in a hard-wired manner. In any of those embodiments, whether executing instructions stored on a device readable storage medium or not, processing circuitry 1370 can be configured to perform the described functionality. The benefits provided by such functionality are not limited to processing circuitry 1370 alone or to other components of network node 1360, but are enjoyed by network node 1360 as a whole, and/or by end users and the wireless network generally.

Device readable medium 1380 may comprise any form of volatile or non-volatile computer readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD), and/or any other volatile or non-volatile, non-transitory device readable and/or computer-executable memory devices that store information, data, and/or instructions that may be used by processing circuitry 1370. Device readable medium 1380 may store any suitable instructions, data or information, including a computer program, software, an application including one or more of logic, rules, code, tables, etc. and/or other instructions capable of being executed by processing circuitry 1370 and, utilized by network node 1360. Device readable medium 1380 may be used to store any calculations made by processing circuitry 1370 and/or any data received via interface 1390. In some embodiments, processing circuitry 1370 and device readable medium 1380 may be considered to be integrated.

Interface 1390 is used in the wired or wireless communication of signalling and/or data between network node 1360, network 1306, and/or WDs 1310. As illustrated, interface 1390 comprises port(s)/terminal(s) 1394 to send and receive data, for example to and from network 1306 over a wired connection. Interface 1390 also includes radio front end circuitry 1392 that may be coupled to, or in certain embodiments a part of, antenna 1362. Radio front end circuitry 1392 comprises filters 1398 and amplifiers 1396. Radio front end circuitry 1392 may be connected to antenna 1362 and processing circuitry 1370. Radio front end circuitry may be configured to condition signals communicated between antenna 1362 and processing circuitry 1370. Radio front end circuitry 1392 may receive digital data that is to be sent out to other network nodes or WDs via a wireless connection. Radio front end circuitry 1392 may convert the digital data into a radio signal having the appropriate channel and bandwidth parameters using a combination of filters 1398 and/or amplifiers 1396. The radio signal may then be transmitted via antenna 1362. Similarly, when receiving data, antenna 1362 may collect radio signals which are then converted into digital data by radio front end circuitry 1392. The digital data may be passed to processing circuitry 1370. In other embodiments, the interface may comprise different components and/or different combinations of components.

In certain alternative embodiments, network node 1360 may not include separate radio front end circuitry 1392, instead, processing circuitry 1370 may comprise radio front end circuitry and may be connected to antenna 1362 without separate radio front end circuitry 1392. Similarly, in some embodiments, all or some of RF transceiver circuitry 1372 may be considered a part of interface 1390. In still other embodiments, interface 1390 may include one or more ports or terminals 1394, radio front end circuitry 1392, and RF transceiver circuitry 1372, as part of a radio unit (not shown), and interface 1390 may communicate with baseband processing circuitry 1374, which is part of a digital unit (not shown).

Antenna 1362 may include one or more antennas, or antenna arrays, configured to send and/or receive wireless signals. Antenna 1362 may be coupled to radio front end circuitry 1390 and may be any type of antenna capable of transmitting and receiving data and/or signals wirelessly. In some embodiments, antenna 1362 may comprise one or more omni-directional, sector or panel antennas operable to transmit/receive radio signals between, for example, 2 GHZ and 66 GHZ. An omni-directional antenna may be used to transmit/receive radio signals in any direction, a sector antenna may be used to transmit/receive radio signals from devices within a particular area, and a panel antenna may be a line of sight antenna used to transmit/receive radio signals in a relatively straight line. In some instances, the use of more than one antenna may be referred to as MIMO. In certain embodiments, antenna 1362 may be separate from network node 1360 and may be connectable to network node 1360 through an interface or port.

Antenna 1362, interface 1390, and/or processing circuitry 1370 may be configured to perform any receiving operations and/or certain obtaining operations described herein as being performed by a network node. Any information, data and/or signals may be received from a wireless device, another network node and/or any other network equipment. Similarly, antenna 1362, interface 1390, and/or processing circuitry 1370 may be configured to perform any transmitting operations described herein as being performed by a network node. Any information, data and/or signals may be transmitted to a wireless device, another network node and/or any other network equipment.

Power circuitry 1387 may comprise, or be coupled to, power management circuitry and is configured to supply the components of network node 1360 with power for performing the functionality described herein. Power circuitry 1387 may receive power from power source 1386. Power source 1386 and/or power circuitry 1387 may be configured to provide power to the various components of network node 1360 in a form suitable for the respective components (e.g., at a voltage and current level needed for each respective component). Power source 1386 may either be included in, or external to, power circuitry 1387 and/or network node 1360. For example, network node 1360 may be connectable to an external power source (e.g., an electricity outlet) via an input circuitry or interface such as an electrical cable, whereby the external power source supplies power to power circuitry 1387. As a further example, power source 1386 may comprise a source of power in the form of a battery or battery pack which is connected to, or integrated in, power circuitry 1387. The battery may provide backup power should the external power source fail. Other types of power sources, such as photovoltaic devices, may also be used.

Alternative embodiments of network node 1360 may include additional components beyond those shown in FIG. 13 that may be responsible for providing certain aspects of the network node's functionality, including any of the functionality described herein and/or any functionality necessary to support the subject matter described herein. For example, network node 1360 may include user interface equipment to allow input of information into network node 1360 and to allow output of information from network node 1360. This may allow a user to perform diagnostic, maintenance, repair, and other administrative functions for network node 1360.

As used herein, wireless device (WD) refers to a device capable, configured, arranged and/or operable to communicate wirelessly with network nodes and/or other wireless devices. Unless otherwise noted, the term WD may be used interchangeably herein with user equipment (UE). Communicating wirelessly may involve transmitting and/or receiving wireless signals using electromagnetic waves, radio waves, infrared waves, and/or other types of signals suitable for conveying information through air. In some embodiments, a WD may be configured to transmit and/or receive information without direct human interaction. For instance, a WD may be designed to transmit information to a network on a predetermined schedule, when triggered by an internal or external event, or in response to requests from the network. Examples of a WD include, but are not limited to, a smart phone, a mobile phone, a cell phone, a voice over IP (VOIP) phone, a wireless local loop phone, a desktop computer, a personal digital assistant (PDA), a wireless cameras, a gaming console or device, a music storage device, a playback appliance, a wearable terminal device, a wireless endpoint, a mobile station, a tablet, a laptop, a laptop-embedded equipment (LEE), a laptop-mounted equipment (LME), a smart device, a wireless customer-premise equipment (CPE). a vehicle-mounted wireless terminal device, etc. A WD may support device-to-device (D2D) communication, for example by implementing a 3GPP standard for sidelink communication, vehicle-to-vehicle (V2V), vehicle-to-infrastructure (V2I), vehicle-to-everything (V2X) and may in this case be referred to as a D2D communication device. As yet another specific example, in an Internet of Things (IoT) scenario, a WD may represent a machine or other device that performs monitoring and/or measurements, and transmits the results of such monitoring and/or measurements to another WD and/or a network node. The WD may in this case be a machine-to-machine (M2M) device, which may in a 3GPP context be referred to as an MTC device. As one particular example, the WD may be a UE implementing the 3GPP narrow band internet of things (NB-IOT) standard. Particular examples of such machines or devices are sensors, metering devices such as power meters, industrial machinery, or home or personal appliances (e.g. refrigerators, televisions, etc.) personal wearables (e.g., watches, fitness trackers, etc.). In other scenarios, a WD may represent a vehicle or other equipment that is capable of monitoring and/or reporting on its operational status or other functions associated with its operation. A WD as described above may represent the endpoint of a wireless connection, in which case the device may be referred to as a wireless terminal. Furthermore, a WD as described above may be mobile, in which case it may also be referred to as a mobile device or a mobile terminal.

As illustrated, wireless device 1310 includes antenna 1311, interface 1314, processing circuitry 1320, device readable medium 1330, user interface equipment 1332, auxiliary equipment 1334, power source 1336 and power circuitry 1337. WD 1310 may include multiple sets of one or more of the illustrated components for different wireless technologies supported by WD 1310, such as, for example, GSM, WCDMA, LTE, NR, WiFi, WiMAX, or Bluetooth wireless technologies, just to mention a few. These wireless technologies may be integrated into the same or different chips or set of chips as other components within WD 1310.

Antenna 1311 may include one or more antennas or antenna arrays, configured to send and/or receive wireless signals, and is connected to interface 1314. In certain alternative embodiments, antenna 1311 may be separate from WD 1310 and be connectable to WD 1310 through an interface or port. Antenna 1311, interface 1314, and/or processing circuitry 1320 may be configured to perform any receiving or transmitting operations described herein as being performed by a WD. Any information, data and/or signals may be received from a network node and/or another WD. In some embodiments, radio front end circuitry and/or antenna 1311 may be considered an interface.

As illustrated, interface 1314 comprises radio front end circuitry 1312 and antenna 1311. Radio front end circuitry 1312 comprise one or more filters 1318 and amplifiers 1316. Radio front end circuitry 1314 is connected to antenna 1311 and processing circuitry 1320, and is configured to condition signals communicated between antenna 1311 and processing circuitry 1320. Radio front end circuitry 1312 may be coupled to or a part of antenna 1311. In some embodiments, WD 1310 may not include separate radio front end circuitry 1312; rather, processing circuitry 1320 may comprise radio front end circuitry and may be connected to antenna 1311. Similarly, in some embodiments, some or all of RF transceiver circuitry 1322 may be considered a part of interface 1314. Radio front end circuitry 1312 may receive digital data that is to be sent out to other network nodes or WDs via a wireless connection. Radio front end circuitry 1312 may convert the digital data into a radio signal having the appropriate channel and bandwidth parameters using a combination of filters 1318 and/or amplifiers 1316. The radio signal may then be transmitted via antenna 1311. Similarly, when receiving data, antenna 1311 may collect radio signals which are then converted into digital data by radio front end circuitry 1312. The digital data may be passed to processing circuitry 1320. In other embodiments, the interface may comprise different components and/or different combinations of components.

Processing circuitry 1320 may comprise a combination of one or more of a microprocessor, controller, microcontroller, central processing unit, digital signal processor, application-specific integrated circuit, field programmable gate array, or any other suitable computing device, resource, or combination of hardware, software, and/or encoded logic operable to provide, either alone or in conjunction with other WD 1310 components, such as device readable medium 1330, WD 1310 functionality. Such functionality may include providing any of the various wireless features or benefits discussed herein. For example, processing circuitry 1320 may execute instructions stored in device readable medium 1330 or in memory within processing circuitry 1320 to provide the functionality disclosed herein.

As illustrated, processing circuitry 1320 includes one or more of RF transceiver circuitry 1322, baseband processing circuitry 1324, and application processing circuitry 1326. In other embodiments, the processing circuitry may comprise different components and/or different combinations of components. In certain embodiments processing circuitry 1320 of WD 1310 may comprise a SOC. In some embodiments, RF transceiver circuitry 1322, baseband processing circuitry 1324, and application processing circuitry 1326 may be on separate chips or sets of chips. In alternative embodiments, part or all of baseband processing circuitry 1324 and application processing circuitry 1326 may be combined into one chip or set of chips, and RF transceiver circuitry 1322 may be on a separate chip or set of chips. In still alternative embodiments, part or all of RF transceiver circuitry 1322 and baseband processing circuitry 1324 may be on the same chip or set of chips, and application processing circuitry 1326 may be on a separate chip or set of chips. In yet other alternative embodiments, part or all of RF transceiver circuitry 1322, baseband processing circuitry 1324, and application processing circuitry 1326 may be combined in the same chip or set of chips. In some embodiments, RF transceiver circuitry 1322 may be a part of interface 1314. RF transceiver circuitry 1322 may condition RF signals for processing circuitry 1320.

In certain embodiments, some or all of the functionality described herein as being performed by a WD may be provided by processing circuitry 1320 executing instructions stored on device readable medium 1330, which in certain embodiments may be a computer-readable storage medium. In alternative embodiments, some or all of the functionality may be provided by processing circuitry 1320 without executing instructions stored on a separate or discrete device readable storage medium, such as in a hard-wired manner. In any of those particular embodiments, whether executing instructions stored on a device readable storage medium or not, processing circuitry 1320 can be configured to perform the described functionality. The benefits provided by such functionality are not limited to processing circuitry 1320 alone or to other components of WD 1310, but are enjoyed by WD 1310 as a whole, and/or by end users and the wireless network generally.

Processing circuitry 1320 may be configured to perform any determining, calculating, or similar operations (e.g., certain obtaining operations) described herein as being performed by a WD. These operations, as performed by processing circuitry 1320, may include processing information obtained by processing circuitry 1320 by, for example, converting the obtained information into other information, comparing the obtained information or converted information to information stored by WD 1310, and/or performing one or more operations based on the obtained information or converted information, and as a result of said processing making a determination.

Device readable medium 1330 may be operable to store a computer program, software, an application including one or more of logic, rules, code, tables, etc. and/or other instructions capable of being executed by processing circuitry 1320. Device readable medium 1330 may include computer memory (e.g., Random Access Memory (RAM) or Read Only Memory (ROM), mass storage media (e.g., a hard disk), removable storage media (e.g., a Compact Disk (CD) or a Digital Video Disk (DVD)), and/or any other volatile or non-volatile, non-transitory device readable and/or computer executable memory devices that store information, data, and/or instructions that may be used by processing circuitry 1320. In some embodiments, processing circuitry 1320 and device readable medium 1330 may be considered to be integrated.

User interface equipment 1332 may provide components that allow for a human user to interact with WD 1310. Such interaction may be of many forms, such as visual, audial, tactile, etc. User interface equipment 1332 may be operable to produce output to the user and to allow the user to provide input to WD 1310. The type of interaction may vary depending on the type of user interface equipment 1332 installed in WD 1310. For example, if WD 1310 is a smart phone, the interaction may be via a touch screen; if WD 1310 is a smart meter, the interaction may be through a screen that provides usage (e.g., the number of gallons used) or a speaker that provides an audible alert (e.g., if smoke is detected). User interface equipment 1332 may include input interfaces, devices and circuits, and output interfaces, devices and circuits. User interface equipment 1332 is configured to allow input of information into WD 1310, and is connected to processing circuitry 1320 to allow processing circuitry 1320 to process the input information. User interface equipment 1332 may include, for example, a microphone, a proximity or other sensor, keys/buttons, a touch display, one or more cameras, a USB port, or other input circuitry. User interface equipment 1332 is also configured to allow output of information from WD 1310, and to allow processing circuitry 1320 to output information from WD 1310. User interface equipment 1332 may include, for example, a speaker, a display, vibrating circuitry, a USB port, a headphone interface, or other output circuitry. Using one or more input and output interfaces, devices, and circuits, of user interface equipment 1332, WD 1310 may communicate with end users and/or the wireless network, and allow them to benefit from the functionality described herein.

Auxiliary equipment 1334 is operable to provide more specific functionality which may not be generally performed by WDs. This may comprise specialized sensors for doing measurements for various purposes, interfaces for additional types of communication such as wired communications etc. The inclusion and type of components of auxiliary equipment 1334 may vary depending on the embodiment and/or scenario.

Power source 1336 may, in some embodiments, be in the form of a battery or battery pack. Other types of power sources, such as an external power source (e.g., an electricity outlet), photovoltaic devices or power cells, may also be used. WD 1310 may further comprise power circuitry 1337 for delivering power from power source 1336 to the various parts of WD 1310 which need power from power source 1336 to carry out any functionality described or indicated herein. Power circuitry 1337 may in certain embodiments comprise power management circuitry. Power circuitry 1337 may additionally or alternatively be operable to receive power from an external power source; in which case WD 1310 may be connectable to the external power source (such as an electricity outlet) via input circuitry or an interface such as an electrical power cable. Power circuitry 1337 may also in certain embodiments be operable to deliver power from an external power source to power source 1336. This may be, for example, for the charging of power source 1336. Power circuitry 1337 may perform any formatting, converting, or other modification to the power from power source 1336 to make the power suitable for the respective components of WD 1310 to which power is supplied.

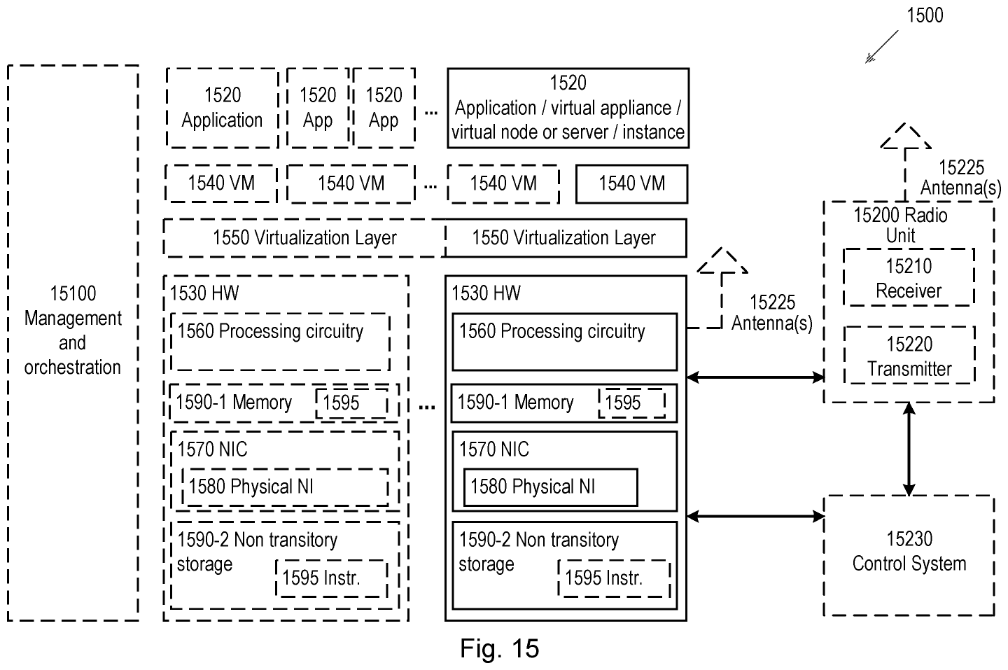

FIG. 14 illustrates one embodiment of a UE in accordance with various aspects described herein. As used herein, a user equipment or UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter). UE 1400 may be any UE identified by the 3^{rd} Generation Partnership Project (3GPP), including a NB-IOT UE, a machine type communication (MTC) UE, and/or an enhanced MTC (eMTC) UE. UE 1400, as illustrated in FIG. 14, is one example of a WD configured for communication in accordance with one or more communication standards promulgated by the 3^{rd} Generation Partnership Project (3GPP), such as 3GPP's GSM, UMTS, LTE, and/or 5G standards. As mentioned previously, the term WD and UE may be used interchangeable. Accordingly, although FIG. 14 is a UE, the components discussed herein are equally applicable to a WD, and vice-versa.

In FIG. 14, UE 1400 includes processing circuitry 1401 that is operatively coupled to input/output interface 1405, radio frequency (RF) interface 1409, network connection interface 1411, memory 1415 including random access memory (RAM) 1417, read-only memory (ROM) 1419, and storage medium 1421 or the like, communication subsystem 1431, power source 1433, and/or any other component, or any combination thereof. Storage medium 1421 includes operating system 1423, application program 1425, and data 1427. In other embodiments, storage medium 1421 may include other similar types of information. Certain UEs may utilize all of the components shown in FIG. 14, or only a subset of the components. The level of integration between the components may vary from one UE to another UE. Further, certain UEs may contain multiple instances of a component, such as multiple processors, memories, transceivers, transmitters, receivers, etc.

In FIG. 14, processing circuitry 1401 may be configured to process computer instructions and data. Processing circuitry 1401 may be configured to implement any sequential state machine operative to execute machine instructions stored as machine-readable computer programs in the memory, such as one or more hardware-implemented state machines (e.g., in discrete logic, FPGA, ASIC, etc.); programmable logic together with appropriate firmware; one or more stored program, general-purpose processors, such as a microprocessor or Digital Signal Processor (DSP), together with appropriate software; or any combination of the above. For example, the processing circuitry 1401 may include two central processing units (CPUs). Data may be information in a form suitable for use by a computer.

In the depicted embodiment, input/output interface 1405 may be configured to provide a communication interface to an input device, output device, or input and output device. UE 1400 may be configured to use an output device via input/output interface 1405. An output device may use the same type of interface port as an input device. For example, a USB port may be used to provide input to and output from UE 1400. The output device may be a speaker, a sound card, a video card, a display, a monitor, a printer, an actuator, an emitter, a smartcard, another output device, or any combination thereof. UE 1400 may be configured to use an input device via input/output interface 1405 to allow a user to capture information into UE 1400. The input device may include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, another like sensor, or any combination thereof. For example, the input device may be an accelerometer, a magnetometer, a digital camera, a microphone, and an optical sensor.

In FIG. 14, RF interface 1409 may be configured to provide a communication interface to RF components such as a transmitter, a receiver, and an antenna. Network connection interface 1411 may be configured to provide a communication interface to network 1443a. Network 1443a may encompass wired and/or wireless networks such as a local-area network (LAN), a wide-area network (WAN), a computer network, a wireless network, a telecommunications network, another like network or any combination thereof. For example, network 1443a may comprise a Wi-Fi network. Network connection interface 1411 may be configured to include a receiver and a transmitter interface used to communicate with one or more other devices over a communication network according to one or more communication protocols, such as Ethernet, TCP/IP, SONET, ATM, or the like. Network connection interface 1411 may implement receiver and transmitter functionality appropriate to the communication network links (e.g., optical, electrical, and the like). The transmitter and receiver functions may share circuit components, software or firmware, or alternatively may be implemented separately.

RAM 1417 may be configured to interface via bus 1402 to processing circuitry 1401 to provide storage or caching of data or computer instructions during the execution of software programs such as the operating system, application programs, and device drivers. ROM 1419 may be configured to provide computer instructions or data to processing circuitry 1401. For example, ROM 1419 may be configured to store invariant low-level system code or data for basic system functions such as basic input and output (I/O), startup, or reception of keystrokes from a keyboard that are stored in a non-volatile memory. Storage medium 1421 may be configured to include memory such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, or flash drives. In one example, storage medium 1421 may be configured to include operating system 1423, application program 1425 such as a web browser application, a widget or gadget engine or another application, and data file 1427. Storage medium 1421 may store, for use by UE 1400, any of a variety of various operating systems or combinations of operating systems.

Storage medium 1421 may be configured to include a number of physical drive units, such as redundant array of independent disks (RAID), floppy disk drive, flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as a subscriber identity module or a removable user identity (SIM/RUIM) module, other memory, or any combination thereof. Storage medium 1421 may allow UE 1400 to access computer-executable instructions, application programs or the like, stored on transitory or non-transitory memory media, to off-load data, or to upload data. An article of manufacture, such as one utilizing a communication system may be tangibly embodied in storage medium 1421, which may comprise a device readable medium.

In FIG. 14, processing circuitry 1401 may be configured to communicate with network 1443b using communication subsystem 1431. Network 1443a and network 1443b may be the same network or networks or different network or networks. Communication subsystem 1431 may be configured to include one or more transceivers used to communicate with network 1443b. For example, communication subsystem 1431 may be configured to include one or more transceivers used to communicate with one or more remote transceivers of another device capable of wireless communication such as another WD, UE, or base station of a radio access network (RAN) according to one or more communication protocols, such as IEEE 802.11, CDMA, WCDMA, GSM, LTE, UTRAN, WiMax, or the like. Each transceiver may include transmitter 1433 and/or receiver 1435 to implement transmitter or receiver functionality, respectively, appropriate to the RAN links (e.g., frequency allocations and the like). Further, transmitter 1433 and receiver 1435 of each transceiver may share circuit components, software or firmware, or alternatively may be implemented separately.

In the illustrated embodiment, the communication functions of communication subsystem 1431 may include data communication, voice communication, multimedia communication, short-range communications such as Bluetooth, near-field communication, location-based communication such as the use of the global positioning system (GPS) to determine a location, another like communication function, or any combination thereof. For example, communication subsystem 1431 may include cellular communication, Wi-Fi communication, Bluetooth communication, and GPS communication. Network 1443b may encompass wired and/or wireless networks such as a local-area network (LAN), a wide-area network (WAN), a computer network, a wireless network, a telecommunications network, another like network or any combination thereof. For example, network 1443b may be a cellular network, a Wi-Fi network, and/or a near-field network. Power source 1413 may be configured to provide alternating current (AC) or direct current (DC) power to components of UE 1400.

The features, benefits and/or functions described herein may be implemented in one of the components of UE 1400 or partitioned across multiple components of UE 1400. Further, the features, benefits, and/or functions described herein may be implemented in any combination of hardware, software or firmware. In one example, communication subsystem 1431 may be configured to include any of the components described herein. Further, processing circuitry 1401 may be configured to communicate with any of such components over bus 1402. In another example, any of such components may be represented by program instructions stored in memory that when executed by processing circuitry 1401 perform the corresponding functions described herein. In another example, the functionality of any of such components may be partitioned between processing circuitry 1401 and communication subsystem 1431. In another example, the non-computationally intensive functions of any of such components may be implemented in software or firmware and the computationally intensive functions may be implemented in hardware.

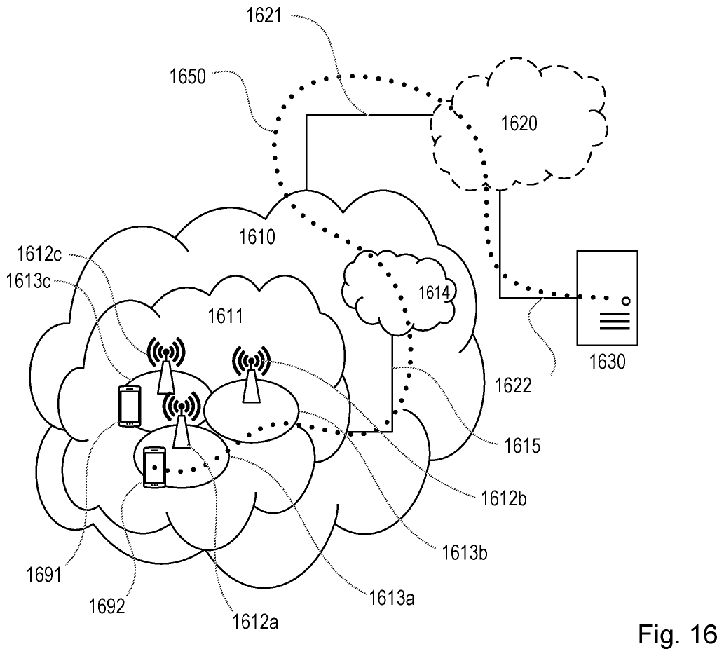

FIG. 15 is a schematic block diagram illustrating a virtualization environment 1500 in which functions implemented by some embodiments may be virtualized. In the present context, virtualizing means creating virtual versions of apparatuses or devices which may include virtualizing hardware platforms, storage devices and networking resources. As used herein, virtualization can be applied to a node (e.g., a virtualized base station or a virtualized radio access node) or to a device (e.g., a UE, a wireless device or any other type of communication device) or components thereof and relates to an implementation in which at least a portion of the functionality is implemented as one or more virtual components (e.g., via one or more applications, components, functions, virtual machines or containers executing on one or more physical processing nodes in one or more networks).

In some embodiments, some or all of the functions described herein may be implemented as virtual components executed by one or more virtual machines implemented in one or more virtual environments 1500 hosted by one or more of hardware nodes 1530. Further, in embodiments in which the virtual node is not a radio access node or does not require radio connectivity (e.g., a core network node), then the network node may be entirely virtualized.

The functions may be implemented by one or more applications 1520 (which may alternatively be called software instances, virtual appliances, network functions, virtual nodes, virtual network functions, etc.) operative to implement some of the features, functions, and/or benefits of some of the embodiments disclosed herein. Applications 1520 are run in virtualization environment 1500 which provides hardware 1530 comprising processing circuitry 1560 and memory 1590. Memory 1590 contains instructions 1595 executable by processing circuitry 1560 whereby application 1520 is operative to provide one or more of the features, benefits, and/or functions disclosed herein.

Virtualization environment 1500, comprises general-purpose or special-purpose network hardware devices 1530 comprising a set of one or more processors or processing circuitry 1560, which may be commercial off-the-shelf (COTS) processors, dedicated Application Specific Integrated Circuits (ASICs), or any other type of processing circuitry including digital or analog hardware components or special purpose processors. Each hardware device may comprise memory 1590-1 which may be non-persistent memory for temporarily storing instructions 1595 or software executed by processing circuitry 1560. Each hardware device may comprise one or more network interface controllers (NICs) 1570, also known as network interface cards, which include physical network interface 1580. Each hardware device may also include non-transitory, persistent, machine-readable storage media 1590-2 having stored therein software 1595 and/or instructions executable by processing circuitry 1560. Software 1595 may include any type of software including software for instantiating one or more virtualization layers 1550 (also referred to as hypervisors), software to execute virtual machines 1540 as well as software allowing it to execute functions, features and/or benefits described in relation with some embodiments described herein.

Virtual machines 1540, comprise virtual processing, virtual memory, virtual networking or interface and virtual storage, and may be run by a corresponding virtualization layer 1550 or hypervisor. Different embodiments of the instance of virtual appliance 1520 may be implemented on one or more of virtual machines 1540, and the implementations may be made in different ways.

During operation, processing circuitry 1560 executes software 1595 to instantiate the hypervisor or virtualization layer 1550, which may sometimes be referred to as a virtual machine monitor (VMM). Virtualization layer 1550 may present a virtual operating platform that appears like networking hardware to virtual machine 1540.

As shown in FIG. 15, hardware 1530 may be a standalone network node with generic or specific components. Hardware 1530 may comprise antenna 15225 and may implement some functions via virtualization. Alternatively, hardware 1530 may be part of a larger cluster of hardware (e.g. such as in a data center or customer premise equipment (CPE) where many hardware nodes work together and are managed via management and orchestration (MANO) 15100, which, among others, oversees lifecycle management of applications 1520.

Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, virtual machine 1540 may be a software implementation of a physical machine that runs programs as if they were executing on a physical, non-virtualized machine. Each of virtual machines 1540, and that part of hardware 1530 that executes that virtual machine, be it hardware dedicated to that virtual machine and/or hardware shared by that virtual machine with others of the virtual machines 1540, forms a separate virtual network elements (VNE).

Still in the context of NFV, Virtual Network Function (VNF) is responsible for handling specific network functions that run in one or more virtual machines 1540 on top of hardware networking infrastructure 1530 and corresponds to application 1520 in FIG. 15.

In some embodiments, one or more radio units 15200 that each include one or more transmitters 15220 and one or more receivers 15210 may be coupled to one or more antennas 15225. Radio units 15200 may communicate directly with hardware nodes 1530 via one or more appropriate network interfaces and may be used in combination with the virtual components to provide a virtual node with radio capabilities, such as a radio access node or a base station.

In some embodiments, some signalling can be effected with the use of control system 15230 which may alternatively be used for communication between the hardware nodes 1530 and radio units 15200.

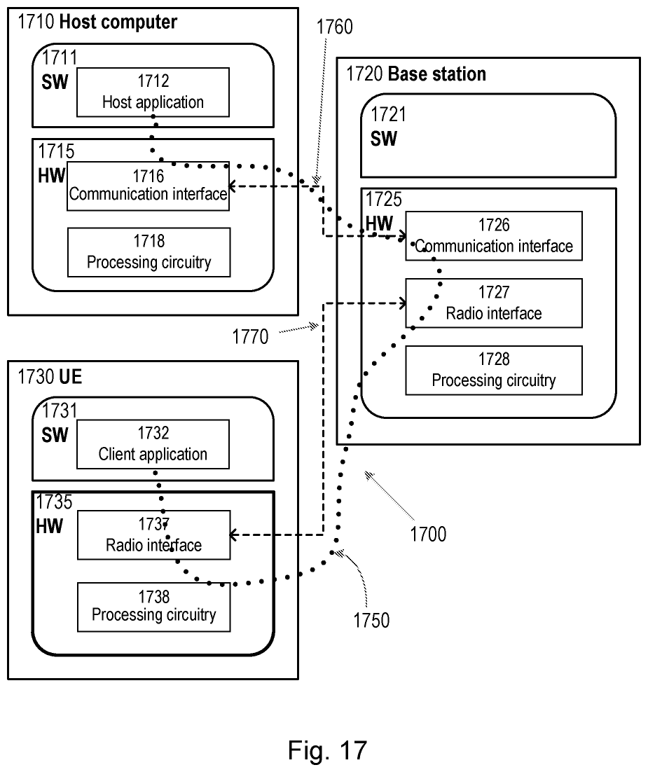

With reference to FIG. 16, in accordance with an embodiment, a communication system includes telecommunication network 1610, such as a 3GPP-type cellular network, which comprises access network 1611, such as a radio access network, and core network 1614. Access network 1611 comprises a plurality of base stations 1612a, 1612b, 1612c, such as NBs, eNBs, gNBs or other types of wireless access points, each defining a corresponding coverage area 1613a, 1613b, 1613c. Each base station 1612a, 1612b, 1612c is connectable to core network 1614 over a wired or wireless connection 1615. A first UE 1691 located in coverage area 1613c is configured to wirelessly connect to, or be paged by, the corresponding base station 1612c. A second UE 1692 in coverage area 1613a is wirelessly connectable to the corresponding base station 1612a. While a plurality of UEs 1691, 1692 are illustrated in this example, the disclosed embodiments are equally applicable to a situation where a sole UE is in the coverage area or where a sole UE is connecting to the corresponding base station 1612.

Telecommunication network 1610 is itself connected to host computer 1630, which may be embodied in the hardware and/or software of a standalone server, a cloud-implemented server, a distributed server or as processing resources in a server farm. Host computer 1630 may be under the ownership or control of a service provider, or may be operated by the service provider or on behalf of the service provider. Connections 1621 and 1622 between telecommunication network 1610 and host computer 1630 may extend directly from core network 1614 to host computer 1630 or may go via an optional intermediate network 1620. Intermediate network 1620 may be one of, or a combination of more than one of, a public, private or hosted network; intermediate network 1620, if any, may be a backbone network or the Internet; in particular, intermediate network 1620 may comprise two or more sub-networks (not shown).

The communication system of FIG. 16 as a whole enables connectivity between the connected UEs 1691, 1692 and host computer 1630. The connectivity may be described as an over-the-top (OTT) connection 1650. Host computer 1630 and the connected UEs 1691, 1692 are configured to communicate data and/or signalling via OTT connection 1650, using access network 1611, core network 1614, any intermediate network 1620 and possible further infrastructure (not shown) as intermediaries. OTT connection 1650 may be transparent in the sense that the participating communication devices through which OTT connection 1650 passes are unaware of routing of uplink and downlink communications. For example, base station 1612 may not or need not be informed about the past routing of an incoming downlink communication with data originating from host computer 1630 to be forwarded (e.g., handed over) to a connected UE 1691. Similarly, base station 1612 need not be aware of the future routing of an outgoing uplink communication originating from the UE 1691 towards the host computer 1630.

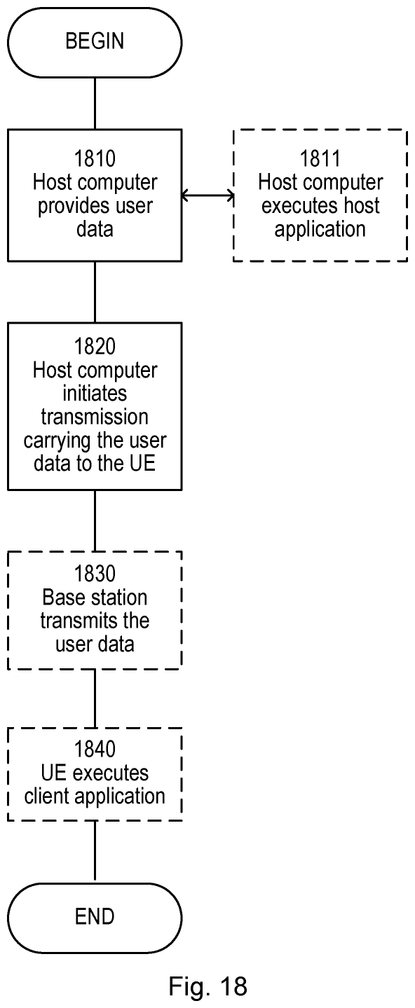

Example implementations, in accordance with an embodiment, of the UE, base station and host computer discussed in the preceding paragraphs will now be described with reference to FIG. 17. In communication system 1700, host computer 1710 comprises hardware 1715 including communication interface 1716 configured to set up and maintain a wired or wireless connection with an interface of a different communication device of communication system 1700. Host computer 1710 further comprises processing circuitry 1718, which may have storage and/or processing capabilities. In particular, processing circuitry 1718 may comprise one or more programmable processors, application-specific integrated circuits, field programmable gate arrays or combinations of these (not shown) adapted to execute instructions. Host computer 1710 further comprises software 1711, which is stored in or accessible by host computer 1710 and executable by processing circuitry 1718. Software 1711 includes host application 1712. Host application 1712 may be operable to provide a service to a remote user, such as UE 1730 connecting via OTT connection 1750 terminating at UE 1730 and host computer 1710. In providing the service to the remote user, host application 1712 may provide user data which is transmitted using OTT connection 1750.

Communication system 1700 further includes base station 1720 provided in a telecommunication system and comprising hardware 1725 enabling it to communicate with host computer 1710 and with UE 1730. Hardware 1725 may include communication interface 1726 for setting up and maintaining a wired or wireless connection with an interface of a different communication device of communication system 1700, as well as radio interface 1727 for setting up and maintaining at least wireless connection 1770 with UE 1730 located in a coverage area (not shown in FIG. 17) served by base station 1720. Communication interface 1726 may be configured to facilitate connection 1760 to host computer 1710. Connection 1760 may be direct or it may pass through a core network (not shown in FIG. 17) of the telecommunication system and/or through one or more intermediate networks outside the telecommunication system. In the embodiment shown, hardware 1725 of base station 1720 further includes processing circuitry 1728, which may comprise one or more programmable processors, application-specific integrated circuits, field programmable gate arrays or combinations of these (not shown) adapted to execute instructions. Base station 1720 further has software 1721 stored internally or accessible via an external connection.

Communication system 1700 further includes UE 1730 already referred to. Its hardware 1735 may include radio interface 1737 configured to set up and maintain wireless connection 1770 with a base station serving a coverage area in which UE 1730 is currently located. Hardware 1735 of UE 1730 further includes processing circuitry 1738, which may comprise one or more programmable processors, application-specific integrated circuits, field programmable gate arrays or combinations of these (not shown) adapted to execute instructions. UE 1730 further comprises software 1731, which is stored in or accessible by UE 1730 and executable by processing circuitry 1738. Software 1731 includes client application 1732. Client application 1732 may be operable to provide a service to a human or non-human user via UE 1730, with the support of host computer 1710. In host computer 1710, an executing host application 1712 may communicate with the executing client application 1732 via OTT connection 1750 terminating at UE 1730 and host computer 1710. In providing the service to the user, client application 1732 may receive request data from host application 1712 and provide user data in response to the request data. OTT connection 1750 may transfer both the request data and the user data. Client application 1732 may interact with the user to generate the user data that it provides.

It is noted that host computer 1710, base station 1720 and UE 1730 illustrated in FIG. 17 may be similar or identical to host computer 1630, one of base stations 1612a, 1612b, 1612c and one of UEs 1691, 1692 of FIG. 16, respectively. This is to say, the inner workings of these entities may be as shown in FIG. 17 and independently, the surrounding network topology may be that of FIG. 16.

In FIG. 17, OTT connection 1750 has been drawn abstractly to illustrate the communication between host computer 1710 and UE 1730 via base station 1720, without explicit reference to any intermediary devices and the precise routing of messages via these devices. Network infrastructure may determine the routing, which it may be configured to hide from UE 1730 or from the service provider operating host computer 1710, or both. While OTT connection 1750 is active, the network infrastructure may further take decisions by which it dynamically changes the routing (e.g., on the basis of load balancing consideration or reconfiguration of the network).

Wireless connection 1770 between UE 1730 and base station 1720 is in accordance with the teachings of the embodiments described throughout this disclosure. One or more of the various embodiments improve the performance of OTT services provided to UE 1730 using OTT connection 1750, in which wireless connection 1770 forms the last segment. More precisely, the teachings of these embodiments may improve the reduce signalling and thereby provide benefits such as better responsiveness.

A measurement procedure may be provided for the purpose of monitoring data rate, latency and other factors on which the one or more embodiments improve. There may further be an optional network functionality for reconfiguring OTT connection 1750 between host computer 1710 and UE 1730, in response to variations in the measurement results. The measurement procedure and/or the network functionality for reconfiguring OTT connection 1750 may be implemented in software 1711 and hardware 1715 of host computer 1710 or in software 1731 and hardware 1735 of UE 1730, or both. In embodiments, sensors (not shown) may be deployed in or in association with communication devices through which OTT connection 1750 passes; the sensors may participate in the measurement procedure by supplying values of the monitored quantities exemplified above, or supplying values of other physical quantities from which software 1711, 1731 may compute or estimate the monitored quantities. The reconfiguring of OTT connection 1750 may include message format, retransmission settings, preferred routing etc.; the reconfiguring need not affect base station 1720, and it may be unknown or imperceptible to base station 1720. Such procedures and functionalities may be known and practiced in the art. In certain embodiments, measurements may involve proprietary UE signalling facilitating host computer 1710's measurements of throughput, propagation times, latency and the like. The measurements may be implemented in that software 1711 and 1731 causes messages to be transmitted, in particular empty or ‘dummy’ messages, using OTT connection 1750 while it monitors propagation times, errors etc.

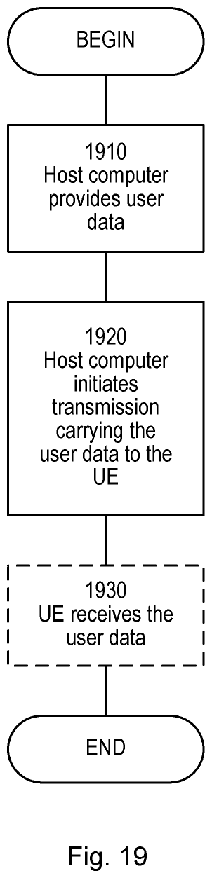

FIG. 18 is a flowchart illustrating a method implemented in a communication system, in accordance with one embodiment. The communication system includes a host computer, a base station and a UE which may be those described with reference to FIGS. 16 and 17. For simplicity of the present disclosure, only drawing references to FIG. 18 will be included in this section. In step 1810, the host computer provides user data. In substep 1811 (which may be optional) of step 1810, the host computer provides the user data by executing a host application. In step 1820, the host computer initiates a transmission carrying the user data to the UE. In step 1830 (which may be optional), the base station transmits to the UE the user data which was carried in the transmission that the host computer initiated, in accordance with the teachings of the embodiments described throughout this disclosure. In step 1840 (which may also be optional), the UE executes a client application associated with the host application executed by the host computer.

FIG. 19 is a flowchart illustrating a method implemented in a communication system, in accordance with one embodiment. The communication system includes a host computer, a base station and a UE which may be those described with reference to FIGS. 16 and 17. For simplicity of the present disclosure, only drawing references to FIG. 19 will be included in this section. In step 1910 of the method, the host computer provides user data. In an optional substep (not shown) the host computer provides the user data by executing a host application. In step 1920, the host computer initiates a transmission carrying the user data to the UE. The transmission may pass via the base station, in accordance with the teachings of the embodiments described throughout this disclosure. In step 1930 (which may be optional), the UE receives the user data carried in the transmission.

FIG. 20 is a flowchart illustrating a method implemented in a communication system, in accordance with one embodiment. The communication system includes a host computer, a base station and a UE which may be those described with reference to FIGS. 16 and 17. For simplicity of the present disclosure, only drawing references to FIG. 20 will be included in this section. In step 2010 (which may be optional), the UE receives input data provided by the host computer. Additionally or alternatively, in step 2020, the UE provides user data. In substep 2021 (which may be optional) of step 2020, the UE provides the user data by executing a client application. In substep 2011 (which may be optional) of step 2010, the UE executes a client application which provides the user data in reaction to the received input data provided by the host computer. In providing the user data, the executed client application may further consider user input received from the user. Regardless of the specific manner in which the user data was provided, the UE initiates, in substep 2030 (which may be optional), transmission of the user data to the host computer. In step 2040 of the method, the host computer receives the user data transmitted from the UE, in accordance with the teachings of the embodiments described throughout this disclosure.

FIG. 21 is a flowchart illustrating a method implemented in a communication system, in accordance with one embodiment. The communication system includes a host computer, a base station and a UE which may be those described with reference to FIGS. 16 and 17. For simplicity of the present disclosure, only drawing references to FIG. 21 will be included in this section. In step 2110 (which may be optional), in accordance with the teachings of the embodiments described throughout this disclosure, the base station receives user data from the UE. In step 2120 (which may be optional), the base station initiates transmission of the received user data to the host computer. In step 2130 (which may be optional), the host computer receives the user data carried in the transmission initiated by the base station.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

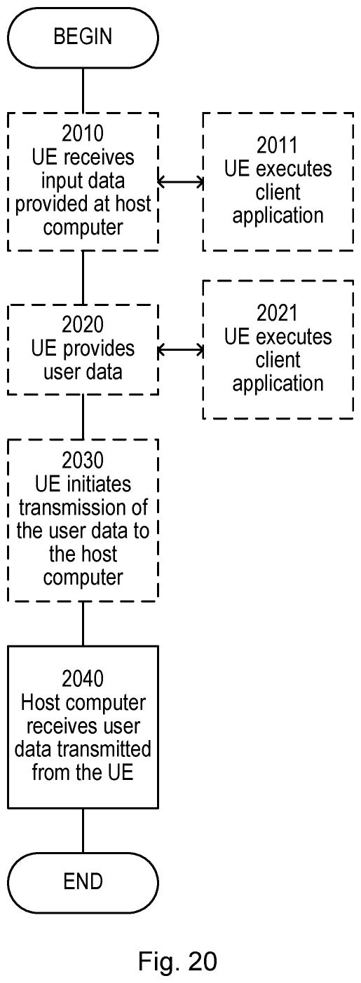

FIG. 22 illustrates a schematic block diagram of an apparatus 2200 in a wireless network (for example, the wireless network shown in FIG. 13). The apparatus may be implemented in a wireless device or network node (e.g., wireless device 1310 or network node 1360 shown in FIG. 13). Apparatus 2200 is operable to carry out the example method described with reference to FIG. 8 and possibly any other processes or methods disclosed herein. It is also to be understood that the method of FIG. 8 is not necessarily carried out solely by apparatus 2200. At least some operations of the method can be performed by one or more other entities.

Virtual Apparatus 2200 may comprise processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory includes program instructions for executing one or more telecommunications and/or data communications protocols as well as instructions for carrying out one or more of the techniques described herein, in several embodiments. In some implementations, the processing circuitry may be used to cause Signalling unit 2202, and any other suitable units of apparatus 2200 to perform corresponding functions according one or more embodiments of the present disclosure.

As illustrated in FIG. 22, apparatus 2200 includes Signalling unit 2202. Signalling unit 2202 is configured to signal an indication of a type of the neural network encoder to the base station.

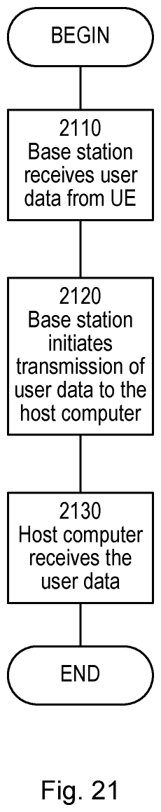

FIG. 23 illustrates a schematic block diagram of an apparatus 2300 in a wireless network (for example, the wireless network shown in FIG. 13). The apparatus may be implemented in a wireless device or network node (e.g., wireless device 1310 or network node 1360 shown in FIG. 13). Apparatus 2300 is operable to carry out the example method described with reference to FIG. 9 and possibly any other processes or methods disclosed herein. It is also to be understood that the method of FIG. 9 is not necessarily carried out solely by apparatus 2300. At least some operations of the method can be performed by one or more other entities.

Virtual Apparatus 2300 may comprise processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory includes program instructions for executing one or more telecommunications and/or data communications protocols as well as instructions for carrying out one or more of the techniques described herein, in several embodiments. In some implementations, the processing circuitry may be used to cause Receiving unit 2302, and any other suitable units of apparatus 2300 to perform corresponding functions according one or more embodiments of the present disclosure.

As illustrated in FIG. 23, apparatus 2300 includes Receiving unit 2302. Receiving unit 2302 is configured to receive an indication of a type neural network encoder used by a wireless device.

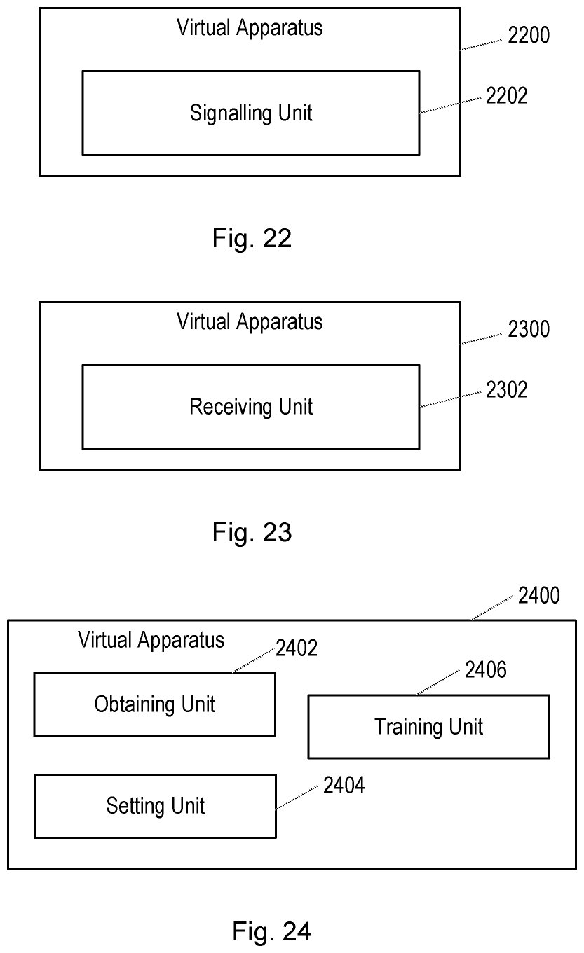

FIG. 24 illustrates a schematic block diagram of an apparatus 2400. The apparatus may be implemented in a network node. The network node may be a RAN node or base station, a node in a core network, or a node outside of the RAN and core of a network. Apparatus 2400 is operable to carry out the example method described with reference to FIG. 6 and possibly any other processes or methods disclosed herein. It is also to be understood that the method of FIG. 6 is not necessarily carried out solely by apparatus 2400. At least some operations of the method can be performed by one or more other entities.

Virtual Apparatus 2400 may comprise processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory includes program instructions for executing one or more telecommunications and/or data communications protocols as well as instructions for carrying out one or more of the techniques described herein, in several embodiments. In some implementations, the processing circuitry may be used to cause Obtaining unit 2402, Setting Unit 2404 and Training Unit 2406 and any other suitable units of apparatus 2400 to perform corresponding functions according one or more embodiments of the present disclosure.

As illustrated in FIG. 24, apparatus 2400 includes Obtaining unit 2402 configured to obtain a first set of weights, Setting Unit 2404 configured to set weights of the first neural network encoder to the first set of weights, and Training Unit 2406 configured to train the first neural network decoder using a second data set, during which the weights of the first neural network encoder are fixed.

The term unit may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

### Embodiments

1. A method of training an autoencoder in a target domain, wherein the autoencoder comprises a first neural network encoder for use in a wireless device and a first neural network decoder for use in a base station, the method comprising:
   training a second neural network encoder in a source domain using a first data set to determine a first set of weights, wherein the second neural network encoder has the same structure as the first neural network encoder;
   setting weights of the first neural network encoder to the first set of weights; and
   training the first neural network decoder using a second data set, during which the weights of the first neural network encoder are fixed.
2. The method of embodiment 1 wherein the first data set comprises simulated channel data of a wireless channel.
3. The method of embodiment 1 or 2 wherein the second data set comprises measurements or uplink measurements.
4. The method of any previous embodiment wherein the first neural network decoder is of a different structure to a second neural network decoder in the source domain.
5. The method of any previous embodiment wherein the wireless device signals to the base station a type of the first neural network encoder.
6. A network node for training an autoencoder, wherein autoencoder comprises a first neural network encoder for use in a wireless device and a first neural network decoder for use in a base station, wherein the network node comprises processing circuitry configured to:
   receive a first set of weights;
   set the weights of a first neural network encoder to the first set of weights; and
   train the first neural network decoder using a second data set, during which the weights of the first neural network encoder are fixed.

### Group A Embodiments

7. A method performed by a wireless device for providing a compressed Channel State Information (CSI) to a base station, the wireless device comprising a neural network encoder configured to determine the compressed Channel State Information (CSI), wherein the neural network encoder is configured with a first set of weights, the method comprising:
   signalling an indication of a type of the neural network encoder to the base station.
8. The method of embodiment 7 further comprising:
   receiving an update to one or more of the first set of weights from the base station.
9. The method of embodiment 8 further comprising storing the first set of weights.
10. The method of embodiment of embodiment 8 or 9 further comprising:
   receiving a request from the base station to convert back to the first set of weights.
11. The method of embodiment 8 wherein the update is received via Radio Resource Control signalling.
12. The method of any of the previous embodiments, further comprising:
   a. providing user data; and
   b. forwarding the user data to a host computer via the transmission to the base station.

### Group B Embodiments

13. A method performed by a base station for determining Channel State Information (CSI), the base station comprising a neural network decoder configured to decompress compressed CSI received from a wireless device, wherein a neural network encoder in the wireless device is configured with a first set of weights, the method comprising:
   receiving an indication of a type neural network encoder used by a wireless device.
14. The method of embodiment 13 further comprising:
   selecting a neural network decoder based on the indication; and
   using the neural network decoder to decompress the compressed CSI.
15. The method of any one of embodiments 13 to 14 further comprising:
   transmitting an update to one or more of the first set of weights to the wireless device.
16. The method of embodiment 15 further comprising:
   transmitting a request to the wireless device to convert back to the first set of weights.
17. The method of embodiment 15 wherein the update is transmitted via Radio Resource Control signalling.

### Group C Embodiments

18. A wireless device for providing a compressed Channel State Information (CSI) to a base station, the wireless device comprising:
   processing circuitry configured to perform any of the steps of any of the Group A embodiments; and
   power supply circuitry configured to supply power to the wireless device.
19. A base station for determining Channel State Information (CSI), the base station comprising:
   processing circuitry configured to perform any of the steps of any of the Group B embodiments;
   power supply circuitry configured to supply power to the base station.
20. A user equipment (UE) for providing a compressed Channel State Information (CSI) to a base station, the UE comprising:
   an antenna configured to send and receive wireless signals;
   radio front-end circuitry connected to the antenna and to processing circuitry, and configured to condition signals communicated between the antenna and the processing circuitry;
   the processing circuitry being configured to perform any of the steps of any of the Group A embodiments;
   an input interface connected to the processing circuitry and configured to allow input of information into the UE to be processed by the processing circuitry;
   an output interface connected to the processing circuitry and configured to output information from the UE that has been processed by the processing circuitry; and
   a battery connected to the processing circuitry and configured to supply power to the UE.
21. A communication system including a host computer comprising:
   processing circuitry configured to provide user data; and
   a communication interface configured to forward the user data to a cellular network for transmission to a user equipment (UE),
   wherein the cellular network comprises a base station having a radio interface and processing circuitry, the base station's processing circuitry configured to perform any of the steps of any of the Group B embodiments.
22. The communication system of the previous embodiment further including the base station.
23. The communication system of the previous 2 embodiments, further including the UE, wherein the UE is configured to communicate with the base station.
24. The communication system of the previous 3 embodiments, wherein:
   the processing circuitry of the host computer is configured to execute a host application, thereby providing the user data; and
   the UE comprises processing circuitry configured to execute a client application associated with the host application.
25. A method implemented in a communication system including a host computer, a base station and a user equipment (UE), the method comprising:
   at the host computer, providing user data; and
   at the host computer, initiating a transmission carrying the user data to the UE via a cellular network comprising the base station, wherein the base station performs any of the steps of any of the Group B embodiments.
26. The method of the previous embodiment, further comprising, at the base station, transmitting the user data.
27. The method of the previous 2 embodiments, wherein the user data is provided at the host computer by executing a host application, the method further comprising, at the UE, executing a client application associated with the host application.
28. A user equipment (UE) configured to communicate with a base station, the UE comprising a radio interface and processing circuitry configured to performs the of the previous 3 embodiments.
29. A communication system including a host computer comprising:
   processing circuitry configured to provide user data; and
   a communication interface configured to forward user data to a cellular network for transmission to a user equipment (UE),
   wherein the UE comprises a radio interface and processing circuitry, the UE's components configured to perform any of the steps of any of the Group A embodiments.
30. The communication system of the previous embodiment, wherein the cellular network further includes a base station configured to communicate with the UE.
31. The communication system of the previous 2 embodiments, wherein:
   the processing circuitry of the host computer is configured to execute a host application, thereby providing the user data; and
   the UE's processing circuitry is configured to execute a client application associated with the host application.
32. A method implemented in a communication system including a host computer, a base station and a user equipment (UE), the method comprising:
   at the host computer, providing user data; and
   at the host computer, initiating a transmission carrying the user data to the UE via a cellular network comprising the base station, wherein the UE performs any of the steps of any of the Group A embodiments.
33. The method of the previous embodiment, further comprising at the UE, receiving the user data from the base station.
34. A communication system including a host computer comprising:
   communication interface configured to receive user data originating from a transmission from a user equipment (UE) to a base station,
   wherein the UE comprises a radio interface and processing circuitry, the UE's processing circuitry configured to perform any of the steps of any of the Group A embodiments.
35. The communication system of the previous embodiment, further including the UE.
36. The communication system of the previous 2 embodiments, further including the base station, wherein the base station comprises a radio interface configured to communicate with the UE and a communication interface configured to forward to the host computer the user data carried by a transmission from the UE to the base station.
37. The communication system of the previous 3 embodiments, wherein:
   the processing circuitry of the host computer is configured to execute a host application; and
   the UE's processing circuitry is configured to execute a client application associated with the host application, thereby providing the user data.
38. The communication system of the previous 4 embodiments, wherein:
   the processing circuitry of the host computer is configured to execute a host application, thereby providing request data; and
   the UE's processing circuitry is configured to execute a client application associated with the host application, thereby providing the user data in response to the request data.
39. A method implemented in a communication system including a host computer, a base station and a user equipment (UE), the method comprising:
   at the host computer, receiving user data transmitted to the base station from the UE, wherein the UE performs any of the steps of any of the Group A embodiments.
40. The method of the previous embodiment, further comprising, at the UE, providing the user data to the base station.
41. The method of the previous 2 embodiments, further comprising:
   at the UE, executing a client application, thereby providing the user data to be transmitted; and
   at the host computer, executing a host application associated with the client application.
42. The method of the previous 3 embodiments, further comprising:
   at the UE, executing a client application; and
   at the UE, receiving input data to the client application, the input data being provided at the host computer by executing a host application associated with the client application,
   wherein the user data to be transmitted is provided by the client application in response to the input data.
43. A communication system including a host computer comprising a communication interface configured to receive user data originating from a transmission from a user equipment (UE) to a base station, wherein the base station comprises a radio interface and processing circuitry, the base station's processing circuitry configured to perform any of the steps of any of the Group B embodiments.
44. The communication system of the previous embodiment further including the base station.
45. The communication system of the previous 2 embodiments, further including the UE, wherein the UE is configured to communicate with the base station.
46. The communication system of the previous 3 embodiments, wherein:
   the processing circuitry of the host computer is configured to execute a host application;
   the UE is configured to execute a client application associated with the host application, thereby providing the user data to be received by the host computer.
47. A method implemented in a communication system including a host computer, a base station and a user equipment (UE), the method comprising:
   at the host computer, receiving, from the base station, user data originating from a transmission which the base station has received from the UE, wherein the UE performs any of the steps of any of the Group A embodiments.
48. The method of the previous embodiment, further comprising at the base station, receiving the user data from the UE.
49. The method of the previous 2 embodiments, further comprising at the base station, initiating a transmission of the received user data to the host computer.

### ABBREVIATIONS

At least some of the following abbreviations may be used in this disclosure. If there is an inconsistency between abbreviations, preference should be given to how it is used above. If listed multiple times below, the first listing should be preferred over any subsequent listing(s).

| | | | |
|---|---|---|---|
| AE | Auto Encoder | AWGN | Additive White Gaussian Noise |
| BS | Base Station | BCCH | Broadcast Control Channel |
| CDF | Cumulative Distribution Function | BCH | Broadcast Channel |
| CE | Channel Estimate | CA | Carrier Aggregation |
| CIR | Channel Impulse Response | CC | Carrier Component |
| CSI | Channel State Information | CCCH SDU | Common Control Channel SDU |
| DFT | Discrete Fourier Transform | CDMA | Code Division Multiplexing |
| DL | DownLink | | Access |
| ML | Machine Learning | CGI | Cell Global Identifier |
| MU-MIMO | Multi User - Multiple Input | CIR | Channel Impulse Response |
| | Multiple Output | CP | Cyclic Prefix |
| NMSE | Normalized Mean Squared Error | CPICH | Common Pilot Channel |
| PCA | Principal Component Analysis | CPICH Ec/No | CPICH Received energy per |
| PMI | Precoder Matrix Indicator | | chip divided by the power |
| RI | Rank Indicator | | density in the band |
| TL | Transfer Learning | CQI | Channel Quality information |
| UE | User Equipment | C-RNTI | Cell RNTI |
| UL | UpLink | CSI | Channel State Information |
| UMa | 3GPP TR38.901 5G Urban | DCCH | Dedicated Control Channel |
| | Macro Channel Model | DL | Downlink |
| UMi | 3GPP TR38.901 5G Urban | DM | Demodulation |
| | Micro Channel Model | DMRS | Demodulation Reference Signal |
| 1x RTT | CDMA2000 1x Radio | DRX | Discontinuous Reception |
| | Transmission Technology | DTX | Discontinuous Transmission |
| 3GPP | 3rd Generation Partnership | DTCH | Dedicated Traffic Channel |
| | Project | DUT | Device Under Test |
| 5G | 5th Generation | E-CID | Enhanced Cell-ID (positioning |
| ABS | Almost Blank Subframe | | method) |
| ARQ | Automatic Repeat Request | E-SMLC | Evolved-Serving Mobile |
| ECGI | Evolved CGI | | Location Centre |
| eNB | E-UTRAN NodeB | MME | Mobility Management Entity |
| ePDCCH | enhanced Physical Downlink | MSC | Mobile Switching Center |
| | Control Channel | NPDCCH | Narrowband Physical Downlink |
| E-SMLC | evolved Serving Mobile Location | | Control Channel |
| | Center | NR | New Radio |
| E-UTRA | Evolved UTRA | OCNG | OFDMA Channel Noise |
| E-UTRAN | Evolved UTRAN | | Generator |
| FDD | Frequency Division Duplex | OFDM | Orthogonal Frequency Division |
| FFS | For Further Study | | Multiplexing |
| GERAN | GSM EDGE Radio Access | OFDMA | Orthogonal Frequency Division |
| | Network | | Multiple Access |
| gNB | Base station in NR | OSS | Operations Support System |
| GNSS | Global Navigation Satellite | OTDOA | Observed Time Difference of |
| | System | | Arrival |
| GSM | Global System for Mobile | O&M | Operation and Maintenance |
| | communication | PBCH | Physical Broadcast Channel |
| HARQ | Hybrid Automatic Repeat | P-CCPCH | Primary Common Control |
| | Request | | Physical Channel |
| HO | Handover | PCell | Primary Cell |
| HSPA | High Speed Packet Access | PCFICH | Physical Control Format |
| HRPD | High Rate Packet Data | | Indicator Channel |
| LOS | Line of Sight | PDCCH | Physical Downlink Control |
| LPP | LTE Positioning Protocol | | Channel |
| LTE | Long-Term Evolution | PDP | Profile Delay Profile |
| MAC | Medium Access Control | PDSCH | Physical Downlink Shared |
| MBMS | Multimedia Broadcast Multicast | | Channel |
| | Services | PGW | Packet Gateway |
| MBSFN | Multimedia Broadcast multicast | PHICH | Physical HARQ Indicator |
| | service Single Frequency | | Channel |
| | Network | PLMN | Public Land Mobile Network |
| MBSFN ABS | MBSFN Almost Blank Subframe | PMI | Precoder Matrix Indicator |
| MDT | Minimization of Drive Tests | PRACH | Physical Random Access |
| MIB | Master Information Block | | Channel |
| PSS | Primary Synchronization Signal | PRS | Positioning Reference Signal |
| PUCCH | Physical Uplink Control Channel | SFN | System Frame Number |
| PUSCH | Physical Uplink Shared Channel | SGW | Serving Gateway |
| RACH | Random Access Channel | SI | System Information |
| QAM | Quadrature Amplitude | SIB | System Information Block |
| | Modulation | SNR | Signal to Noise Ratio |
| RAN | Radio Access Network | SON | Self Optimized Network |
| RAT | Radio Access Technology | SS | Synchronization Signal |
| RLM | Radio Link Management | SSS | Secondary Synchronization |
| RNC | Radio Network Controller | | Signal |
| RNTI | Radio Network Temporary | TDD | Time Division Duplex |
| | Identifier | TDOA | Time Difference of Arrival |
| RRC | Radio Resource Control | TOA | Time of Arrival |
| RRM | Radio Resource Management | TSS | Tertiary Synchronization Signal |
| RS | Reference Signal | TTI | Transmission Time Interval |
| RSCP | Received Signal Code Power | UE | User Equipment |
| RSRP | Reference Symbol Received | UL | Uplink |
| | Power OR Reference Signal | UMTS | Universal Mobile |
| | Received Power | | Telecommunication System |
| RSRQ | Reference Signal Received | USIM | Universal Subscriber Identity |
| | Quality OR Reference Symbol | | Module |
| | Received Quality | UTDOA | Uplink Time Difference of |
| RSSI | Received Signal Strength | | Arrival |
| | Indicator | UTRA | Universal Terrestrial Radio |
| RSTD | Reference Signal Time | | Access |
| | Difference | UTRAN | Universal Terrestrial Radio |
| SCH | Synchronization Channel | | Access Network |
| SCell | Secondary Cell | WCDMA | Wide CDMA |
| SDU | Service Data Unit | WLAN | Wide Local Area Network |

1. A method of training an autoencoder in a target domain, the autoencoder comprising a first neural network encoder for use in a wireless device and a first neural network decoder for use in a base station, the method comprising:
obtaining a first set of weights;
setting weights of the first neural network encoder to the first set of weights; and
training the first neural network decoder using a second data set, during which the weights of the first neural network encoder are fixed.

2. The method of claim 1, wherein obtaining a first set of weights comprises training a second neural network encoder in a source domain using a first data set to determine the first set of weights, wherein the second neural network encoder has the same structure as the first neural network encoder.

3. The method of claim 1, wherein obtaining a first set of weights comprises receiving the first set of weights.

4. The method of claim 1, wherein the first data set comprises simulated channel data of a wireless channel.

5. The method of claim 1, wherein the second data set comprises measurements or uplink measurements.

6. The method of claim 1, wherein the first neural network decoder is of a different structure to a second neural network decoder in the source domain.

7. The method of claim 1, wherein the wireless device signals to the base station a type of the first neural network encoder.

8. A method performed by a wireless device for providing a compressed Channel State Information, CSI, to a base station, the wireless device comprising a neural network encoder configured to determine the compressed CSI, the neural network encoder being configured with a first set of weights, the method comprising:
signalling an indication of a type of the neural network encoder to the base station.

9. The method of claim 8, further comprising:
receiving an update to one or more of the first set of weights from the base station.

10. The method of claim 9, further comprising storing the first set of weights.

11. The method of claim 9, further comprising receiving a request from the base station to convert back to the first set of weights.

12. The method of claim 9, wherein the update is received via Radio Resource Control signalling.

13. (canceled)

14. A method performed by a base station for determining Channel State Information, CSI, the base station comprising a neural network decoder configured to decompress compressed CSI received from a wireless device, a neural network encoder in the wireless device being configured with a first set of weights, the method comprising:
receiving an indication of a type of neural network encoder used by a wireless device.

15. The method of claim 14, further comprising:
selecting a neural network decoder based on the indication; and
using the neural network decoder to decompress the compressed CSI.

16. The method of claim 14, further comprising transmitting an update to one or more of the first set of weights to the wireless device.

17. The method of claim 16, further comprising transmitting a request to the wireless device to convert back to the first set of weights.

18. The method of claim 16, wherein the update is transmitted via Radio Resource Control signalling.

19.-37. (canceled)

38. A network node for training an autoencoder, the autoencoder comprising a first neural network encoder for use in a wireless device and a first neural network decoder for use in a base station, the network node comprising a processor and a memory, the memory containing instructions executable by said processor whereby the network node is configured to:
obtain a first set of weights;
set the weights of a first neural network encoder to the first set of weights; and
train the first neural network decoder using a second data set, during which the weights of the first neural network encoder are fixed.

39. The network node of claim 38, wherein the network node is operative to obtain the first set of weights by training a second neural network encoder in a source domain using a first data set to determine the first set of weights, wherein the second neural network encoder has the same structure as the first neural network encoder.

40. The network node of claim 38, wherein the network node is operative to obtain the first set of weights by receiving the first set of weights.

41.-55. (canceled)
